(19) United States
(12) Patent Application Publication
(10) Pub. No.: US 2016/0066261 A1
(43) Pub. Date: Mar. 3, 2016

(54) CONNECTIVITY MANAGEMENT BASED ON COST INFORMATION

(71) Applicant: QUALCOMM Incorporated, San Diego, CA (US)

(72) Inventors: John Wallace Nasielski, San Diego, CA (US); Satashu Goel, San Diego, CA (US); Gavin Bernard Horn, La Jolla, CA (US); Stefano Faccin, Hayward, CA (US)

(21) Appl. No.: 14/683,124

(22) Filed: Apr. 9, 2015

Related U.S. Application Data
(60) Provisional application No. 62/045,441, filed on Sep. 3, 2014.

(51) Int. Cl. H04W 48/18; H04M 15/00

(52) U.S. Cl. CPC H04W 48/18; H04M 15/8038; H04M 15/67; H04M 15/8055

(57) ABSTRACT

Provided is a method operable at a wireless communication device or user device for cost signaling. The user device may receive a first indication of an identity of a network. A second indication of whether a cost information is available may also received by the user device. The cost information may also be associated with the network and indicative of a cost of communicating data via the network. In addition, the user device may query the network for the cost information if the second indication indicates that the cost information is available. The cost information associated with the network may be received by the user device. The user device may select the network based on the received cost information. Communication via the selected network may then be performed by the user device.

### CLAIM OF PRIORITY

The present application for patent claims priority to provisional application No. 62/045,441 entitled “Connectivity Management Based on Cost Information” filed Sep. 3, 2014, the entire disclosure of which is hereby expressly incorporated by reference.

### FIELD

Various features pertain to managing connectivity for wireless communications, and more specifically, managing connectivity based on data for particular wireless networks such as cost information.

### BACKGROUND

In some wireless communication architectures, a user device (e.g., a mobile device, etc.) is able to communicate with different networks. For example, a user device can support connectivity to a cellular network and a Wi-Fi network. Users may prefer Wi-Fi to cellular, especially while roaming, to avoid unknown and potentially expensive charges. To address this user preference, some user devices can be configured to automatically switch from cellular service to Wi-Fi service whenever the user device detects the presence of a Wi-Fi network that the user device is authorized to access. Thus, conventional network selection employs a binary criterion. For example, either cellular or Wi-Fi is selected, based on the availability of the Wi-Fi network. However, there is a need for a method or criteria for a user device to select between more than two networks, for example, based on cost information for the available networks.

### SUMMARY

One feature provides a method operable at a wireless communication device for cost signaling. The user device may receive a first indication of an identity of a network. A second indication of whether a cost information is available may also received by the user device. The cost information may also be associated with the network and indicative of a cost of communicating data via the network. In addition, the user device may query the network for the cost information if the second indication indicates that the cost information is available. The cost information associated with the network may be received by the user device. The user device may select the network based on the received cost information. Communication via the selected network may also be performed via the user device.

According to one aspect, the method also includes sending a request to a cost information server for the cost information associated with the network, the cost information server storing a plurality of cost information arrangements with a plurality of networks including the network. According to another aspect, the sending of the request includes sending an identifier of a client device, the cost information server containing cost information for a plurality of devices, including the client device, with relation to the plurality of networks, the client device including an application on the client device.

According to one aspect, the method also includes receiving the cost information associated with the network from an operator that includes the cost information server, the operator having the plurality of cost information arrangements with the plurality of networks including the network. According to another aspect, the wholesale operator signs the cost information using a certificate.

According to one aspect, the cost information associated with the network is received as a result of receiving the second indication that the cost information is available. According to another aspect, the second indication indicates that a radio access network (RAN) advertises the cost information or indicates the use of an over-the-top server. According to yet another aspect, the cost of communicating data via the network including a cost of establishing connectivity with the network.

According to one aspect, the method also includes invoking a mobility event, the cost information being received in conjunction with the invoking of the mobility event. According to another aspect, the mobility event includes establishing connectivity with at least one network or modifying connectivity with the at least one network, the at least one network including the network.

According to one aspect, receiving the cost information includes receiving the cost information via broadcast signaling. According to another aspect, the cost information includes at least two or more of: a first cost information for an access technology; a second cost information for a wireless spectrum; a third cost information for a subscription; a fourth cost information for a high-level application; a fifth cost information for a service class; a sixth cost information for a location where service charging may occur; a seventh cost information for particular traffic; an eighth cost information for a time of day; a ninth cost information for a first load of a particular cell; a tenth cost information for a second load of a base station; or an eleventh cost information for a dynamic entity. According to yet another aspect, the wireless spectrum includes a licensed spectrum, an unlicensed spectrum, or a shared access spectrum; the subscription includes a home subscription or a roaming subscription; the location where service charging may occur is associated with a geographic location, a network identifier, a public land mobile network (PLMN), a tracking area, a cell identifier, or a service set identifier (SSID); the time of day includes a daytime, an afternoon, or an evening; the particular cell includes a serving cell or a non-serving cell; the base station includes a serving base station or a non-serving base station; and the dynamic entity includes an entity that changes frequently so that the cost information must be calculated for it dynamically.

According to one aspect, the cost information comprises at least one of: a first cost information indication of a free rate, a second cost information indication of a home rate, a third cost information indication of a roaming rate, or a fourth cost information indication of time. According to another aspect, the fourth cost information indication of time relates to at least one of: a duration of activity; a period of time; a time of day; an expiry timer; or a refresh time.

Another feature provides a wireless communication device, including a wireless communication circuit adapted for communications with a network and other devices and a processing circuit coupled to the wireless communication circuit. The processing circuit is configured to: receive a first indication of an identity of the network; receive a second indication of whether a cost information associated with the network is available, the cost information being indicative of a cost of communicating data via the network; query the network for the cost information if the second indication indicates that the cost information is available; receive the cost information associated with the network; select the network based on the received cost information; and communicate via the selected network.

According to one aspect, the wireless communication device also includes a storage device including identifiers for client devices.

According to one aspect, the wireless communication circuit includes at least one transceiver chain, and a modem processor coupled to the processing circuit. According to another aspect, the at least one transceiver chain includes a first transceiver chain including a first radio frequency (RF) front end interface and a first RF processor, the first RF front end interface being coupled to the first RF processor. The at least one transceiver chain also includes a second transceiver chain including a second RF front end interface and a second RF processor, the second RF front end interface being coupled to the second RF processor, the first and second RF front end interfaces communicating with the network and other devices. According to yet another aspect, the modem processor sends a first transmitted signal to the first RF processor and a second transmitted signal to the second RF processor, and also receives a first received signal from the first RF processor and a second received signal from the second RF processor.

Another feature provides a method operable at a network node, including sending a first indication of an identity of a network. The method also includes sending a second indication of whether a cost information associated with the network is available, the cost information being indicative of a cost of communicating data via the network. The method further includes receiving a query for the cost information if the second indication indicates that the cost information is available. The method also includes generating the cost information in response to receiving the query. The method further includes sending the cost information associated with the network. The method also includes receiving a selection of the network based on the sent cost information. The method further includes communicating via the selected network.

According to one aspect, the method also includes receiving a request to a cost information server for the cost information associated with the network, the cost information server storing a plurality of cost information arrangements with a plurality of networks including the network. According to another aspect, the receiving of the request includes receiving an identifier of a client device, the cost information server containing cost information for a plurality of devices, including the client device, with relation to the plurality of networks, the client device including an application on the client device.

According to one aspect, the method also includes receiving the cost information associated with the network from an operator that comprises the cost information server, the operator having the plurality of cost information arrangements with the plurality of networks including the network. According to another aspect, the operator signs the cost information using a certificate. According to yet another aspect, generating the cost information in response to receiving the query is based on various factors including associated subscriptions, traffic conditions, associated applications, and/or roaming status.

According to one aspect, the cost information associated with the network is sent as a result of sending the second indication that the cost information is available.

According to one aspect, the method also includes invoking a mobility event, wherein the cost information is sent in conjunction with the invoking of the mobility event. According to another aspect, the mobility event includes establishing connectivity with at least one network or modifying connectivity with the at least one network, wherein the at least one network includes the network.

According to one aspect, sending the cost information includes sending the cost information via broadcast signaling.

Another feature provides a network communication device, including: a wireless communication circuit adapted for communications with a network and other devices, a network communication circuit adapted for communications with at least one core network, a processing circuit coupled to the wireless communication circuit and the network communication circuit, the processing circuit configured to: send a first indication of an identity of the network; send a second indication of whether cost information associated with the network is available, wherein the cost information is indicative of a cost of communicating data via the network; receive a query for the cost information if the second indication indicates that the cost information is available; generate the cost information in response to receiving the query; send the cost information associated with the network; receive a selection of the network based on the sent cost information; and communicate over the network.

According to one aspect, the network communication device also includes a storage device including identifiers for client devices and identities of networks.

According to one aspect, processing circuit configured to generate the cost information in response to receiving the query is further configured to generate the cost information based on various factors including associated subscriptions, traffic conditions, associated applications, and/or roaming status.

According to one aspect, the network communication circuit includes at least one transceiver chain, and a modem processor coupled to the processing circuit. According to another aspect, the at least one transceiver chain includes a first transceiver chain including a first radio frequency (RF) front end interface and a first RF processor, the first RF front end interface being coupled to the first RF processor. The at least one transceiver chain also includes a second transceiver chain including a second RF front end interface and a second RF processor, the second RF front end interface being coupled to the second RF processor, the first and second RF front end interfaces communicating with at least one core network. According to yet another aspect, the modem processor sends a first transmitted signal to the first RF processor and a second transmitted signal to the second RF processor, and also receives a first received signal from the first RF processor and a second received signal from the second RF processor.

### BRIEF DESCRIPTION OF THE DRAWINGS

FIG. 1 illustrates an example of a system where a connection manager of a user device performs connectivity management based on cost information in accordance with some aspects described herein.

FIG. 2 illustrates an example where a user equipment (UE) can select one or more access networks to use for network access in accordance with some aspects described herein.

FIG. 3 illustrates an example of a system that generates cost information to be signaled to a user device in accordance with some aspects described herein.

FIG. 4 illustrates an example of how cost information can be provided to a mobile device in accordance with some aspects described herein.

FIG. 5 illustrates an example of a system that includes a connection manager in accordance with some aspects described herein.

FIG. 6 illustrates a call flow diagram of various network components dealing with cost information in accordance with some aspects described herein.

FIG. 7 illustrates another call flow diagram of various network components transmitting system information, including cost information, between one another, in accordance with some aspects described herein.

FIG. 8 illustrates yet another call flow diagram of various network components engaging in a query for cost information and the response to that query, in accordance with some aspects described herein.

FIG. 9 illustrates yet another call flow diagram of various network components engaging in a query for cost information and the response to that query which may provide the queried cost information, in accordance with some aspects described herein.

FIG. 10 is a block diagram illustrating a wireless communication device dealing with cost information reception, in accordance with some aspects described herein.

FIG. 11 is a block diagram illustrating a network communication device dealing with cost information generation and transmission, in accordance with some aspects described herein.

FIG. 12 is a block diagram illustrating a wireless communication device dealing with cost information reception and analysis, in accordance with some aspects described herein.

FIG. 13 is a block diagram illustrating a network communication device dealing with cost information transmission for eventual analysis, in accordance with some aspects described herein.

FIG. 14 is a block diagram illustrating a wireless communication device dealing with cost information identification, in accordance with some aspects described herein.

FIG. 15 is a block diagram illustrating a network communication device dealing with the reception of cost information identification, in accordance with some aspects described herein.

FIG. 16 is a block diagram illustrating a network communication device dealing with cost information generation and transmission for eventual analysis, in accordance with some aspects described herein.

FIG. 17 is a block diagram illustrating an exemplary wireless communication circuit that may be used in FIGS. 10-15, in accordance with some aspects described herein.

FIG. 18 illustrates a method operational at a user device for receiving cost information in accordance with some aspects described herein.

FIG. 19 illustrates a method operational at a network node for transmitting cost information in accordance with some aspects described herein.

FIG. 20 illustrates a method operational at a user device for receiving and analyzing cost information in accordance with some aspects of the disclosure.

FIG. 21 illustrates a method operational at a network node for generating and transmitting cost information for eventual analysis, in accordance with some aspects described herein.

FIG. 22 illustrates a method operational at a user device for identifying cost information, in accordance with some aspects described herein.

FIG. 23 illustrates a method operational at a network node for receiving identification of cost information, in accordance with some aspects described herein.

FIG. 24 illustrates a method operational at a network node for generating and transmitting cost information in accordance with some aspects described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

To enable new business models, it is desirable for devices to simplify connectivity decisions on behalf of users. In addition, it is desirable to stitch together unrelated access networks (e.g., access networks without backend roaming coordination) to provide ubiquitous coverage at reasonable cost. The disclosure relates in some aspects to enabling this functionality and other functionality based on cost information.

Conventionally, there is no machine readable cost signal in Wi-Fi or cellular networks. Systems do not support access network selection based on cost (beyond an assumption that Wi-Fi cost=0 or free).

Existing cost-related schemes do not facilitate robust device-based connectivity decisions. For example, “welcome” texts in cellular systems can provide information on possible roaming charges. However, this information is simply carried in a text message readable by a user. Wi-Fi can provide cost information via a captive portal, whereby a user uses a web interface to access this information. However, this involves user actions to click through agreements to get past the captive portal web page. HotSpot 2.0 (HS2.0) Access Network Query Protocol (ANQP) allows a hotspot to discover if it has a roaming agreement with service provider or roaming consortium to which a user station or station (STA) belongs. Access Network Type may be private, private with guest access, chargeable public, free public, personal, and/or emergency services only. But no direct cost signal is provided via HS2.0. A device may derive the knowledge of the cost of Wi-Fi only in terms of realizing whether it is roaming or not. However, even when roaming, the device may be in an equivalent home public land mobile network (HPLMN) where the cost is the same as in the HPLMN. Thus, no actual cost information is provided in that scenario.

In view of the above, the current default cost assumption is that the charging model for Wi-Fi access is unmetered, whereas cellular (3G, 4G, etc.) access costs money to send or receive data or at least has data caps such as a monthly quota. Unfortunately, this can lead to binary behavior such as blocking certain applications (apps) from cellular networks and preventing deployment of novel services that may use Wi-Fi and cellular interfaces simultaneously (e.g., to increase throughput and availability).

Given these limitations, connection managers on devices do not use true cost information to make decisions about where to send or receive data. Moreover, users lack the tools or resources that allow them to efficiently make sensible cost-based decisions. Furthermore, operators may not use cost signals to drive desired behavior or create new business opportunities.

In accordance with the teachings herein, an improved user experience can be provided by supplying a user device with cost information for available interfaces (e.g., network interfaces). Providing such cost information to a user device can enable several improvements to the user interface and the user experience.

Connectivity Decisions.

Connectivity decisions may be made (a) entirely by a connection manager (CM) on the device, for example, (b) by the user, or (c) by the connection manager in conjunction with the user (e.g., by prompting the user to approve exceptional costs or when costs are incurred; or to allow the user to configure the connection manager to unilaterally make certain cost-based decisions for access).

Automatic Least-Cost Interface Selection.

In this mode, the connection manager collects cost information from a plurality of interfaces, and uses cost along with other criteria (e.g., metrics, location) to select the best interface to use at a given point in time. Therefore, a new user experience can be provided to allow for automatic connection management that enforces a preset spending limit.

Scavenger Class Service Offerings.

These types of service can enable end users to pay up for service on an as-needed basis. This could allow operators to offer very low prices to a class of devices that only operate when the network is lightly loaded or not as congested. Advantageously, this class of devices can use cost signals to control their connectivity and to allow for higher levels of service when desired (if the user is willing to pay). This is essentially access-barring based on cost.

“Freemium” Services.

A service provider may chose to provide free or low cost access to entice users to pay for better services upon obtaining cost information. These services allow operators a new channel to market wireless wide area network (WWAN) and wireless local area network (WLAN) data. Basic access may be provided without charge for a limited time and/or at lower or discount data rates. A connection manager gets cost information for improved class(es) of service, potentially over the free link or for certain services. The connection manager and/or the user can then decide to upgrade to a paid subscription (e.g., to add video streaming, or some other service).

Device configuration and policy to use cost signals may be decided by users, service providers, OEMs, application (app) providers, or some combination of the above. Advantageously, the teaching herein can provide a mechanism to facilitate end-to-end negotiation between a service provider (or other suitable entity) and a connection manager at a user device, to thereby facilitate sending cost signals to the connection manager. In addition, connectivity negotiation may occur at a layer above the network operator. For example, an application provider (e.g., Facebook, Google, etc.) may have arrangements with different service providers and have negotiated with different network operators (e.g., cellular and Wi-Fi) to provide preferable rates for the application provider's users. Thus, in some aspects, the teachings herein may support sponsored connectivity (e.g., where a service provider is subsidizing or paying to get packets sent over a network). The network operators that communicate with the connection manager may also be wholesale operators in that they maintain a plurality of cost information or cost signal arrangements with a plurality or multiple networks.

Thus, the teachings herein facilitate new business models that enable service to be provided to a user in a dynamic manner. For example, a user roaming in a non-service area may be allowed temporary access to the network to transact with a specific application (e.g., post to Facebook, or access Gmail from Google). Here, the cost for a given transaction may be presented to the user to enable the user to decide whether to conduct the transaction.

As another example, a user could set a daily budget and the connection manager could then analyze received cost information to determine how best to use that budget to provide connectivity for the user. A cost threshold for a user could be set to prevent the user from being informed about every connectivity decision. For example, concerning connectivity decisions with very low cost, the connection manager might not even inform the user before making a decision. For higher cost decisions, however, the user may be informed so that the user can make the decision.

A user and/or connection manager's response to cost information may be used to override current subscription parameters. For example, a device may be barred from accessing the network at certain hours. However, the device may decide, based on received cost information, to negotiate and pay for access during those barred times.

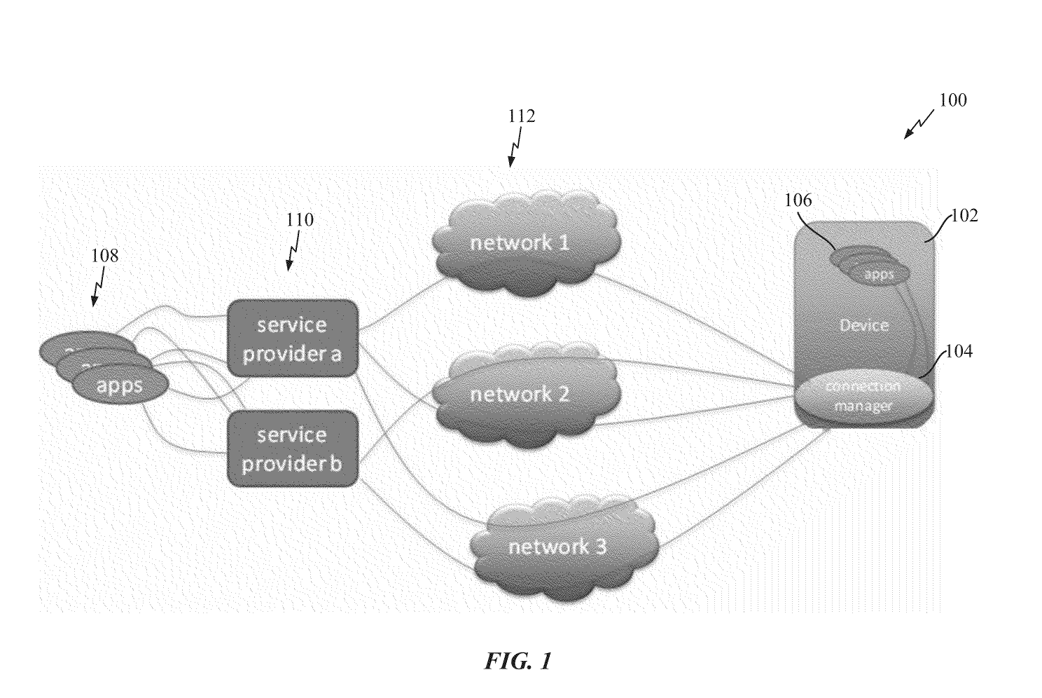

FIG. 1 is a simplified example of a system 100 where a user device 102 includes a connection manager 104 that manages connectivity for the user device 102 based on cost information. This connectivity involves, in some aspects, accessing one or more applications 108 associated with one or more service providers 110. In accordance with the teachings herein, the particular network (access network) 112 the user device 102 uses to access a given service provider 110 or an application 108 associated with a service provider 110 can be selected based on cost information acquired by the connection manager 104. The applications 108 can correspond to, for example, network components such as servers associated with application providers (e.g., Google, Facebook, etc.).

End-user costs are determined by service providers 110 or by service providers 110 in combination with associated applications 108. The networks might not know end user-costs. For example, a service provider 110 might negotiate a resale or wholesale cost agreement for its users. This cost might be irrespective of whether a user is in a home network or roaming.

In some aspects of the disclosure, cost signals and negotiation between a service provider 110 and a connection manager 104 can be implemented in the user device below the application level. This could be done under operator control if the operator manages the connection manager 104 or the input policies to the connection manager 104, or over-the-top (e.g., by communicating with a server outside of the operator network). As used herein, communication with an over-the-top server refers to communicating with a server outside the network by communicating data with the server via the network. The service provider need not be the network operator that deploys the cellular network and/or a non-3GPP network.

In some aspects of the disclosure, cost signals and negotiation between a service provider 110 and a connection manager 104 can be implemented “under the top.” That is, cost signals and negotiations are communicated directly between the network and the connection manager 104.

Advantageously, such cost-based connectivity can be equally applicable to Wi-Fi access, 3G/4G/5G access, and other forms of wireless access.

Cost-based connectivity can support simpler user interface (UI) and user experience (UX). For example, if a user is willing to spend $x/day while roaming, the connection manager 104 can figure out the most cost effective way to use that budget with limited (or no) prompts to user.

Thus, within the user device 102, the received cost information can be used in various ways. For manual selection and user preferences, the cost information for the different networks is presented to the user (e.g., via a user interface such as a display screen). For automatic selection and traffic steering, the cost information is provided to the connection manager 104, whereby the connection manager 104 can apply the cost information to any designated policies and thereby make an appropriate connectivity decision. For example, certain flows may be steered to certain interfaces if these interfaces are lower cost.

The device applications 106 are applications located within the user device 102 that correspond to the applications 108 associated with the service providers 110. An example of a device application 106 would be, for example, an application for an email platform configured for use on a smart phone. The corresponding application 108 to such a device application 106 would be the email server associated with that email platform, or the email platform available via an Internet browser, which would be accessible via a computer, a laptop computer, or similar device that does not have a special device application 106 configured for it. For device applications 106 that may not need real-time connectivity, there can still be a corresponding service layer component that functions as an application 108, to serve ads and collect user data for purposes of analytics, for example. In FIG. 1, a service provider 110 may send a message containing cost signals to the connection manager 104. For example, this message may be sent upon initial connection of the user device 102 to a service provider 110 or serving network 112. The message is consumed by the connection manager 104 for connectivity decisions, if applicable. The message also might be presented to the user. In some aspects, the message may be machine-readable in a standard format.

The connection manager 104 uses cost signals from a plurality of service provider/networks 110, 112 to make connectivity decisions. These decisions also may be based on other data, application requirements, policy (e.g., set by home operator), information received from the network, or other factors. The connection manager 104 could also trigger dynamic subscription management to connect to networks that are not supported by the home operator's cellular or Wi-Fi roaming agreements.

Individual application/service charging can be supported with interfaces to application providers. In some implementations, this could be an extension of a Diameter application between an application function (AF) and a policy and charging rules function (PCRF) in the 3rd Generation Partnership Project (3GPP) architecture. For example, in some aspects, such an interface could be used to extend a 3GPP charging model to over-the-top applications as taught herein.

Cost-based connectivity can also support time-based and congestion-based cost signals. In some embodiments, rates could be fixed. For example, a rate could be specified upon initial connection of a user device to a network. In static scenarios, this rate may remain constant (e.g., for the duration of a connection). By contrast, in dynamic scenarios, this rate can change (e.g., if a network becomes congested, the rate may increase to discourage usage).

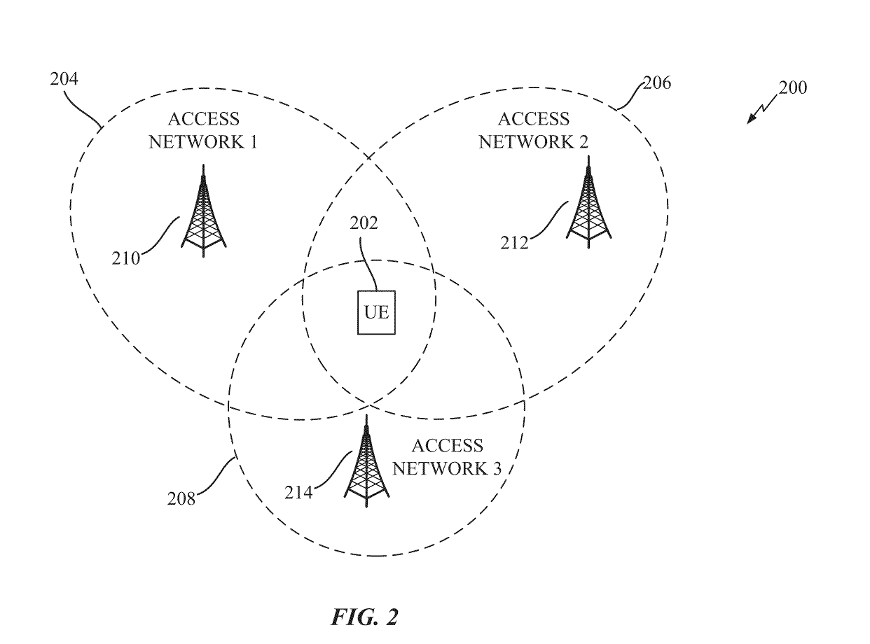

As illustrated in the system 200 of FIG. 2, a user device such as a user equipment (UE) 202 can select one or more access networks 204, 206, 208 to use for a given access operation. A first access network 204 is cast and controlled by a first radio tower 210, a second access network 206 is cast and controlled by a second radio tower 212 and a third access network 208 is cast and controlled by a third radio tower 214. The radio towers 210, 212, 214 control the scope, range and reach of where their respective access networks are effective. As can be seen in FIG. 2, the UE 202 lies within the intersection of all three access networks 204, 206 and 208. The UE 202 is also positioned somewhere in the middle between all three radio towers 210, 212 and 214.

In accordance with the teachings herein, the selection of a given access network from the access networks 204, 206 and 208 can be based on the relative cost of accessing the different access networks 204, 206, 208, as well as other factors as discussed herein. This is where the cost information of a given access network may play a role in the selection of that given access network, because users tend to choose access networks that are cheaper, more efficient and more convenient for usage.

In view of the above, the disclosure relates in some aspects to delivering cost information to a device. The cost information can be sent on a per-user basis (at connectivity establishment, connectivity modification, mobility events, or at other times) to enable network differentiation based on network subscriptions, network conditions (e.g., traffic), the application being invoked, home vs. roaming scenarios, other factors, and/or any combination thereof. Thus, application-specific charging over a plurality of access networks, with or without user intervention, can be achieved.

The cost information can also include a first cost information for an access technology, a second cost information for a wireless spectrum, a third cost information for a subscription, a fourth cost information for a high-level application, a fifth cost information for a service class, a six cost information for a location where service charging may occur, a seventh cost information for particular traffic, an eighth cost information for a time of day, a ninth cost information for a load of a particular cell, a tenth cost information for a load of a base station, an eleventh cost information for a dynamic entity, and any other suitable cost information. The wireless spectrum may include licensed spectrum, unlicensed spectrum, or shared access spectrum. The subscription may include a home subscription or a roaming subscription. The location where service charging may be associated with a geographic location, a network identifier, a public land mobile network (PLMN), a tracking area, a cell identifier, or a service set identifier (SSID). The time of day may include daytime, afternoon or evening. The particular cell may include a serving cell or a non-serving cell. The base station may include a serving base station or a non-serving base station. The dynamic entity may include an entity that changes frequently so that the cost information for it is calculated dynamically. The high-level application can be from an application provider or an application that does not come from an application provider, such as an intelligent modem switch (IMS) application that resides in a modem and comes directly from operators.

The cost information can also include a first cost information indication of a free rate, a second cost information indication of a home rate, a third cost information indication of a roaming rate, and a fourth cost information indication of time. The fourth cost information indication of time relates to at least one of: a duration of activity, a period of time, a time of day, an expiry timer, and/or a refresh time.

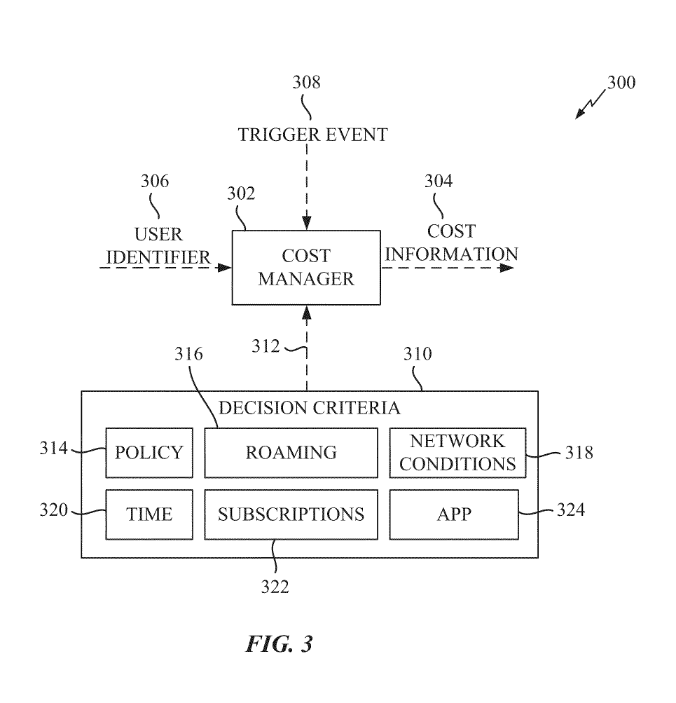

FIG. 3 illustrates an example of a system 300 (e.g., at an application server or a service provider) that generates cost information 304 to be signaled to a user device (not shown). In response to a trigger event 308 such as a connectivity or mobility event for the user device, upon identifying the user device (e.g., via a user identifier 306), a cost manager 302 generates cost information 304 for the user.

In some aspects, this decision can be based on at least one decision criterion 310. The decision criteria 310 may be supplied to the cost manager 302 by at least one connection 312. The decision criteria 310 may include factors such as policy 314 (the type of policy in place for a phone plan or network), roaming 316 (whether the mobile device is roaming or incurring roaming charges), network conditions 318 (the network conditions of a network, e.g., the amount of traffic, whether traffic is congested, whether there is a lot of noise), time 320 (e.g., the time of day and/or geographical location effecting time), subscriptions 322 (e.g., the details of the subscriptions and/or the number of the subscriptions), and applications 324 (e.g., how many applications are being used, the quality of the used applications, and/or details about the application such as different applications specifying different costs). However, it will be understood that the decision criteria 310 is not limited to just these factors and this list is merely exemplary.

A service provider may also define certain policies that affect the cost for certain users or certain groups of users. For example, a preferred group may be presented with a lower cost. As another example, different cost may be associated with connections to different types of access points (e.g., macro cells, small cells such as femto cell or pico cells, and so on).

With respect to cost of establishing and maintaining a connection with a network, the cost can include, for example, costs associated with a session that can expire (e.g., after a certain time), costs for establishing a session, or costs for setting up a link (e.g., a wireless link). Also, cost may depend on whether the user is roaming. For example, a roaming user may be presented with a higher cost than a user that is within his or her home network. Cost can also depend on network conditions such as traffic load, channel quality conditions, and so on. For example, the cost of access may be higher when the network is congested. Cost can further depend on time considerations. For example, the cost of access may be higher at certain times of day, or for longer connections. Cost can depend on any subscriptions for the user. For example, the cost of access may be different for different subscriptions. Cost can depend on the application associated with the access. For example, the cost of access may be different for different applications.

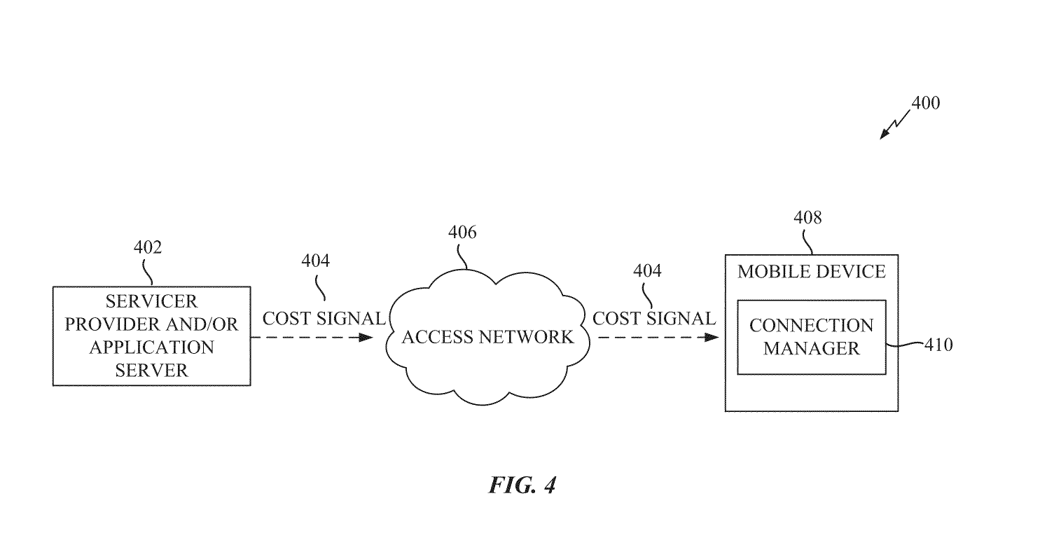

The system 400 of FIG. 4 illustrates an example of how cost information can be provided to a mobile device 408 (e.g., a user device such as a UE). As discussed above, a service provider and/or application server (provider) 402 generates cost information that can be signaled via a cost signal 404 to a mobile device 408. Cost signals, such as the cost signal 404, are thus transmitted to the mobile device 408 via the current serving access network 406 for the mobile device 408. In this way, the connection manager 410 at the mobile device 408 can use the cost information embedded in the cost signals, such as the cost signal 404, to manage connectivity for the mobile device 408.

Cost signals, such as the cost signal 404, can be presented to the mobile device 408 (e.g., connection manager 410) in a standard format. For example, in some implementations, the cost signals can provide a level of granularity indicating whether connectivity is free, the rate applicable to when the user is in a home network, or the rate applicable to when the user is roaming. In some implementations, at a minimum, a cost signal is an offer to provide services at a certain cost for a given period of time. In a non-limiting example where internet access is the basic service, variables that could be included in the cost signal include at least one of: data rate, a range of data rates at different prices, latency guarantee or tiered latencies for different prices, application data and associated pricing (e.g., Facebook access priced differently from best effort data), time period that access is provided, maximum transfer rate, maximum total upload/download data allowed, time of day pricing, congestion pricing, or information to help a connection manager identify the serving network. These variables may be provided through a channel designated for cost signaling, via existing mechanisms, or via other signaling. For example, cost information can be transmitted or received via broadcast signaling.

As discussed above, the disclosure relates in some aspects to improving the user interface and the user experience for automatic system selection, taking cost information into account. Decisions may be made directly by the connection manager 410 without user prompts or input, in some implementations.

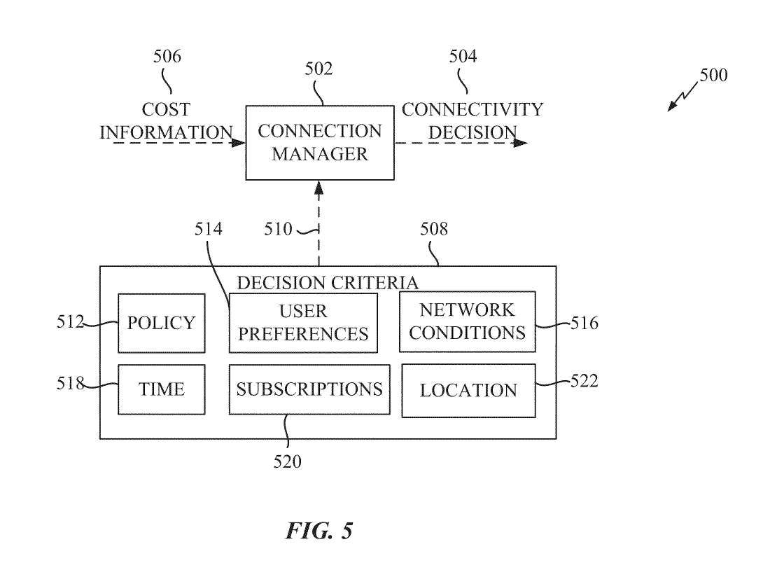

FIG. 5 illustrates an example of a system 500 (e.g., at a mobile device) that includes a connection manager 502. As discussed herein, the connection manager 502 may make a connectivity decision 504 based on the received cost information 506.

In some aspects, this decision can be based on at least one decision criterion 508. The decision criteria 508 may be supplied to the connection manager 502 by at least one connection 510. The decision criteria 508 may include factors such as policy 512 (the type of policy in place for a phone plan or network), user preferences 514 (user-set preferences such as frequency, notifications, and/or phone-based settings picked by the user), network conditions 516 (the amount of traffic, whether traffic is congested, whether there is a lot of noise), time 518 (e.g., the time of day and/or the geographical location effecting time), subscriptions 520 (e.g., the details of the subscriptions and/or the number of the subscriptions), and location 522 (e.g., geographical location, GPS-satellite location, and/or whether the location has strong or poor reception or network quality). However, the decision criteria 508 are not limited to just these factors and this list is merely exemplary.

An operator or service provider may define certain policies that specify what network is to be selected by a particular user. For example, there may be a preference for keeping a user on a certain network whenever the user is near his or her home network.

A user may define certain preferences that specify what network is to be selected based on the current cost. For example, a preferred network may always be selected whenever the current cost is below a threshold cost. A connectivity decision 504 can also depend on network conditions such as traffic load, channel quality conditions, and so on. For example, a user may elect to avoid a lower cost network if the network is congested.

A connectivity decision 504 can depend on time considerations. For example, a user may prefer certain networks at certain times of day. A connectivity decision 504 can depend on subscriptions of the user. For example, the cost of access may be lower if the user has a subscription for a certain service. A connectivity decision 504 can further depend on the location of the user. For example, there may be a preference for certain networks in certain locations.

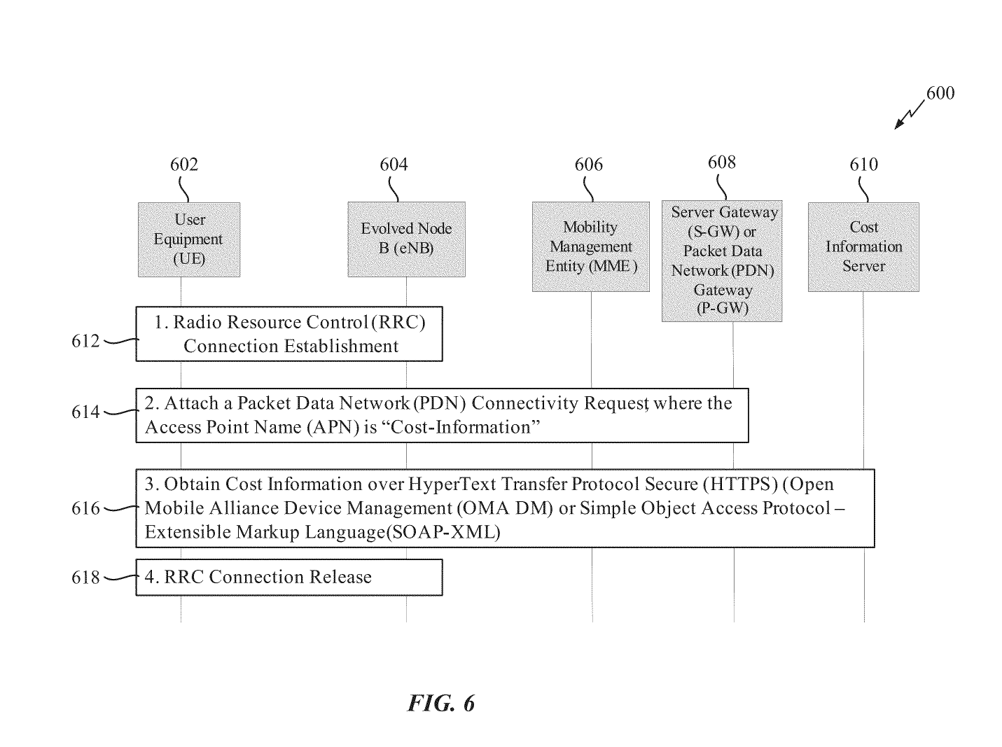

A mobile device (e.g., a connection manager 502) may negotiate with a cost information server (e.g., at an application server or a service provider) via different protocols in different implementations. Several examples of such protocols will be discussed with reference to FIGS. 6-9. Other protocols could be used in other implementations.

Cost information 506 can be delivered to a device via a user plane or a control plane. For the user plane, out-of-band signaling or in-band signaling may be employed. Broadcast signaling may also be employed to deliver cost information 506.

User plane out-of-band signaling may employ open mobile alliance device management (OMA DM), simple object access protocol extensible markup language (SOAP-XML) or some other type of signaling. This signaling can be sent via the operator or over-the-top. Such a signaling method can be employed, for example, to obtain cost information 506 for legacy networks that do not support cost information.

User plane in-band signaling may employ special access point name (APN) or other signaling. A UE can obtain cost information through query/response exchange with a server. On a Wi-Fi network, this can be achieved by querying the captive portal server or another server on the network that provides cost information.

A detailed description of obtaining cost information on a Long Term Evolution (LTE) network is provided next in conjunction with the network 600 shown in FIG. 6. For purposes of illustration, FIG. 6 and other figures herein depict user equipment (UE) 602, evolved Node B (eNB) 604, mobility management entity (MME) 606, server gateway (S-GW) or packet data network (PDN) gateway (P-GW) 608, and other components of an LTE network. It should be appreciated, however, that the teachings herein may be employed in other types of radio technologies and architectures.

At operation 1 (612) in FIG. 6, a UE 602 establishes a radio resource control (RRC) connection with an Evolved Universal Terrestrial Radio Access Network (E-UTRAN) Node B, or evolved Node B (eNB) 604.

At operation 2 (614) in FIG. 6, the UE 602 performs an attach procedure indicating that the UE 602 is seeking cost information, or attaches a packet data network (PDN) connectivity request for cost information. This may be indicated by the use of a specific well-known access point name (APN), e.g. “Cost-Information” or “Cost Information”, or the use of a well-known specific international mobile subscriber identity (IMSI), e.g., all zeros, or the use of an APN created based on the cost information server 610 uniform resource locator (URL). It can also be indicated by defining a new evolved packet system (EPS) attach type value (e.g., “EPS attach for cost information”). It may also be indicated by transmitting a new non-access stratum (NAS) message for the sole purpose of determining the cost of access. It may further be indicated by including a new information element (IE) indicating the server that provides cost information (e.g., via a cost information server index or identifier, a type of server that provides cost information, and/or a default server that provides cost information).

At operation 3 (616) in FIG. 6, the MME 606 proceeds with establishing a non-authenticated non-secure packet data network (PDN) connection with the server gateway or PDN gateway (S-GW/P-GW) 608 restricted to obtaining cost information. To do so, the MME 606 sends a Create Session Request message to the server gateway (S-GW) 608, indicating that the session is for the purpose of obtaining cost information. The message may also include specific information about the allowed cost information server(s), e.g., domain name system (DNS) name, Internet protocol (IP) address. In the S-GW/P-GW 608, the S-GW forwards the request to the P-GW, which accepts the request by sending a Create Session Response to S-GW or the mobility management entity (MME). The MME 606 then initiates default EPS bearer activation towards the eNB 604 and UE 602.

The UE 602 needs to identify itself, even if it is not using an identifier that is valid for registration in this network. To do so, in the EPS mobile identity IE, the UE 602 can use international mobile equipment identity (IMEI) (type of identity 011). IMEI is used today for emergency attach for devices that do not have a valid subscriber identity module (SIM). Another possibility is to define a new type of identity value, similar to an Institute of Electrical and Electronics Engineers (IEEE) medium access control (MAC) address. The UE 602 obtains (e.g., initiates query) a response for cost information with the cost information server 610 over HyperText Transfer Protocol or HyperText Transfer Protocol Secure (HTTP/HTTPS), using Open Mobile Alliance Device Management (OMA DM) or Simple Object Access Protocol-Extensible Markup Language (SOAP-XML), as defined for HotSpot (HS) 2.0. Security is optional.

At operation 4 (618) in FIG. 6, the radio resource control (RRC) connection is released. The control plane cost signaling may also employ broadcast signaling or unicast signaling. For control plane broadcast signaling, the network may broadcast the actual cost information. It may also broadcast information on how to find cost information, e.g., by providing a URL for the cost information server or a bit indicating capability. On a Universal Mobile Telecommunication System (UMTS) or Long Term Evolution (LTE) network, this information can be part of a system information block (SIB). On a Wi-Fi network, this information can be embedded in a beacon.

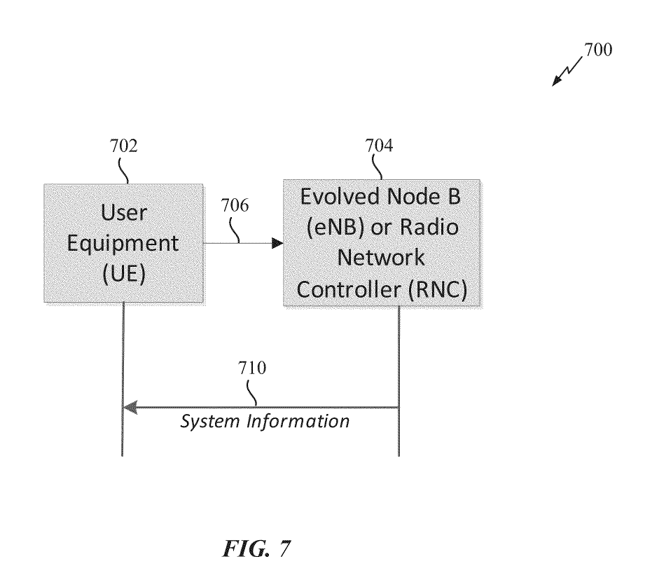

FIG. 7 shows a call flow 700 when an Evolved Universal Terrestrial Radio Access Network (E-UTRAN) Node B, or evolved Node B (eNB) or a radio network controller (RNC) 704 provide cost information via system information 710 to a user equipment (UE) 702 via broadcast. The UE may send a request for cost information 706 to the eNB/RNC 704. In response, the eNB/RNC 704 sends system information 710, which can include cost information associated with a network, to the UE 702.

This transaction shows that network nodes and access points (represented by the eNB/RNC 704) have immediate access to cost information so that the cost information may be transmitted from such network nodes and access points to a UE, a user device or a mobile device. Furthermore, a network node or access point may be able to generate cost information. In addition, if a network node or access point is not able to locate or generate cost information, that cost information can be retrieved from another source such as an operator or other wireless communication device that the eNB/RNC 704 (or network node, access point) can be coupled to, wirelessly or otherwise. Therefore, it is usually the UE 702, user device or mobile device that sends a cost information request 706 to the network node, the access point or eNB/RNC 704 for cost information. As a result of receiving that request, the network node, the access point, or the eNB/RNC 704 sends back the requested cost information to the UE 702, user device or mobile device.

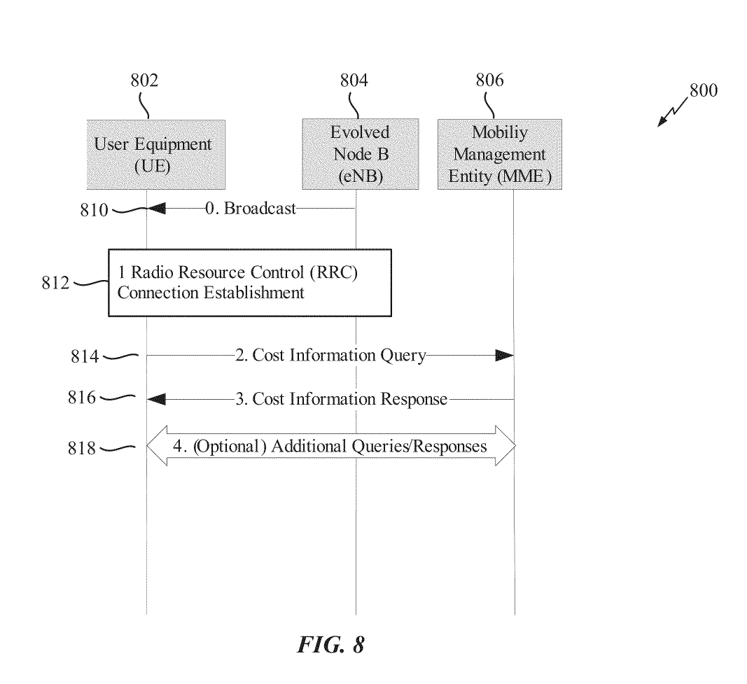

For control plane unicast signaling on a cellular network, cost information can be obtained either over radio resource control (RRC) or non-access stratum (NAS). The call flow 800 of FIG. 8 shows the procedures assuming NAS, but alternatively, operations 3 and 4 can be performed over RRC.

Initially at 810, the eNB 804 sends a broadcast, including for example: a network identifier, and a closed subscriber group identifier (CSG ID) if it applies. In one implementation, the eNB 804 broadcasts this information in system information blocks (SIBs).

At a first operation 812 in FIG. 8, the UE 802 establishes an RRC connection with the eNB 804, indicating a new cause code (e.g., “cost discovery protocol (CDP) query”).

At a second operation 814 in FIG. 8, the UE 802 sends a cost discovery protocol (CDP) query over NAS including a request for cost information to the mobility management entity (MME) 806.

At a third operation 816 in FIG. 8, in one implementation, the CDP signaling is transported from the MME to the UE over Generic NAS transport as defined in the 3rd Generation Partnership Project (3GPP) specification TS (Technical Specification) 24.301. For example, a new type of Generic NAS transport “CDP” is defined for the receiving NAS layer to be able to provide the receiving message to the correct sublayer (CDP or Cost Information). Alternatively, a new NAS CDP request/response pair of messages may be used. The response sent by the MME also contains the cost information requested in the second operation 814.

At a fourth operation 818 in FIG. 8, the MME 806 returns the cost information and online sign up (OSU) Providers List elements to the UE. For more information on the OSU Providers List or OSU, see Wi-Fi Alliance (WFA) HotSpot 2.0/Access Network Query Protocol (ANQPCost information is specific to the subscription information provided by the UE, user device or mobile device).

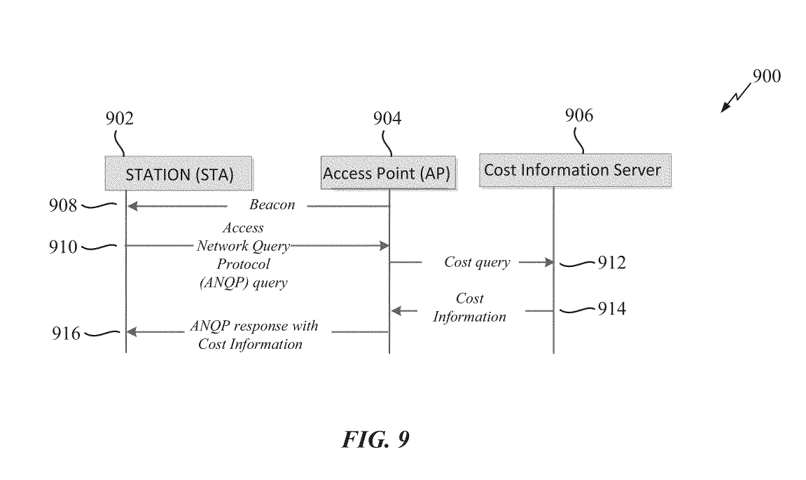

As shown by the call flow 900 of FIG. 9, on a Wi-Fi network, cost information can be obtained using query/response between a user station or station (STA) 902, an access point (AP) 904 and a cost information server 906. For example, in HotSpot 2.0, an access network query protocol (ANQP) query/response can be used. At time 908, the access point 904 transmits a beacon to the station 902. At time 910, the station 902 transmits an ANQP query to the access point 904. The ANQP query contains a request to retrieve specific cost information associated with a network. In one implementation, the ANQP query contains a query about the availability of cost information associated with a network. A time 912, the access point 904 transmits a cost query to the cost information server 906. The cost query is a query to retrieve the cost information requested in the ANQP query at time 910 from the cost information server 906. In one implementation, the cost query sent at time 912 is a query of whether the cost information requested in the ANQP query at time 910 is present or contained by the cost information server 906. If the requested cost information from the cost query in time 912 and the ANQP query in time 910 exists in the cost information server 906, at time 914, the cost information server 906 transmits the requested cost information to the access point 904. At time 916, the access point 904 transmits an ANQP response containing the requested cost information to the station 902, the received cost information being the same cost information requested in the ANQP query transmitted by the station 902 at time 910.

Table 1 illustrates an example of several cost elements that may be employed for cost signaling. Other cost elements also could be used in accordance with the teachings herein.

TABLE 1

| Element Name | Description |
|---|---|
| Cost Information | Provides cost of access and specifies |
| | conditions of applicability, e.g., per |
| | megabyte (Mb), per hour, subscription, |
| | application names, time of day. |
| Expiry time | When the cost information expires, or |
| | how long the information is valid |
| Cost per access technology | To support different costs per radio |
| | access technology (RAT) within the |
| | service provider, e.g., millimeter wave |
| | (mmW), cellular (e.g., 3 G, 4 G, 5 G), |
| | wireless local area network (WLAN) |
| Spectrum type | To support different costs per spectrum |
| | used within the service provider, e.g., |
| | licensed, unlicensed, licensed shared |
| | access, mmW |

Subscription provider

| | |
|---|---|
| Subscription provider ID, e.g., | List of subscription providers for this cell |
| PLMN ID, AN ID, SSID | and associated costs for each provider, |
| | e.g., when a cell is shared among |
| | operators |
| Subscription type | To support different costs for home or |
| | roaming users, e.g., advertise a free rate, |
| | home rate, and a roaming rate |
| Application type | To support different costs per application |
| Service class | To support different costs per type of |
| | traffic, e.g., voice, video, best effort |
| Location | To support different costs per location. |
| | Location may be geographic coordinates |
| | or network ID, e.g., public land mobile |
| | network (PLMN), Tracking area, cell ID, |
| | service set identifier (SSID) |
| Amount of data | Cost per byte |
| Duration of activity | Time of connection |
| Time of day | To support different costs based on the |
| | time access occurs |
| Speed | To support different costs for different |
| | access speeds |

### Exemplary Devices

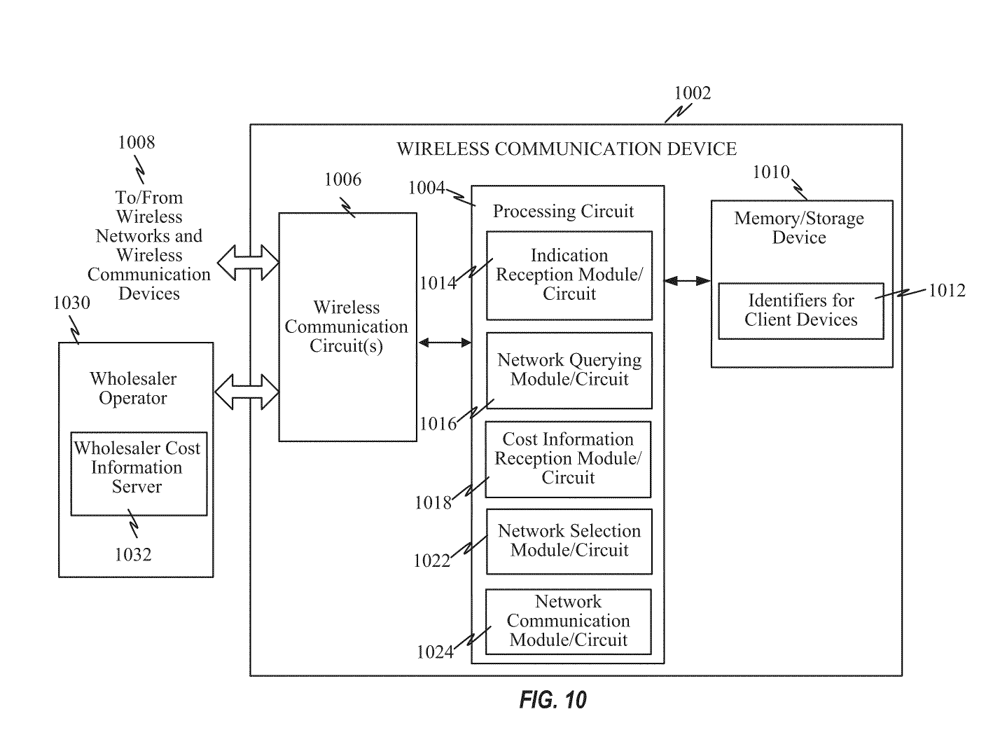

FIG. 10 is a block diagram illustrating a wireless communication device 1002. The wireless communication device 1002 may include a processing circuit 1004 coupled to a wireless communication circuit 1006, and a memory/storage device 1010. The wireless communication circuit 1006 may facilitate wireless communications over two or more distinct wireless networks 1008 or wireless communication devices, such as an operator 1030, which includes a cost information server 1032. The wireless communication device 1002 may be a mobile device, or user device, or user equipment (UE), for example.

The processing circuit 1004 may include or implement an indication reception module/circuit 1014 that permits the wireless communication device 1002 to receive a first indication of an identity of a network and also receive a second indication of whether cost information associated with the network is available.

The processing circuit 1004 may also include or implement a network querying module/circuit 1016 that permits the wireless communication device 1002 to query the network for the cost information if the second indication indicates that the cost information is available.

The processing circuit 1004 may also include or implement a cost information reception module/circuit 1018 that permits the wireless communication device 1002 to receive the cost information associated with the network.

The processing circuit 1004 may also include or implement a network selection module/circuit 1022 that permits the wireless communication device 1002 to select the network based on the received cost information.

The processing circuit 1004 may also include or implement a network communication module/circuit 1024 that permits the wireless communication device 1002 to communicate via the selected network.

The wireless communication device 1002 also contains a memory/storage device 1010, which stores identifiers for client devices 1012. The identifiers for client devices 1012 are used for retrieving cost information associated with identified client devices that are identified by a given identifier. When the wireless communication device 1002 sends a request to another wireless communication device, such as an operator 1030, for cost information corresponding to a particular client device with respect to a particular network, that particular client device is identified with one of the identifiers for the client devices 1012. The identifier also allows the operator 1030 to look within its cost information server 1032 for the appropriate cost information data corresponding to the client device identified with the identifier. The identifier for a client device can also be an identifier for an application or virtual machine for a non-mobile device such as a user device, or an identifier for a mobile device.

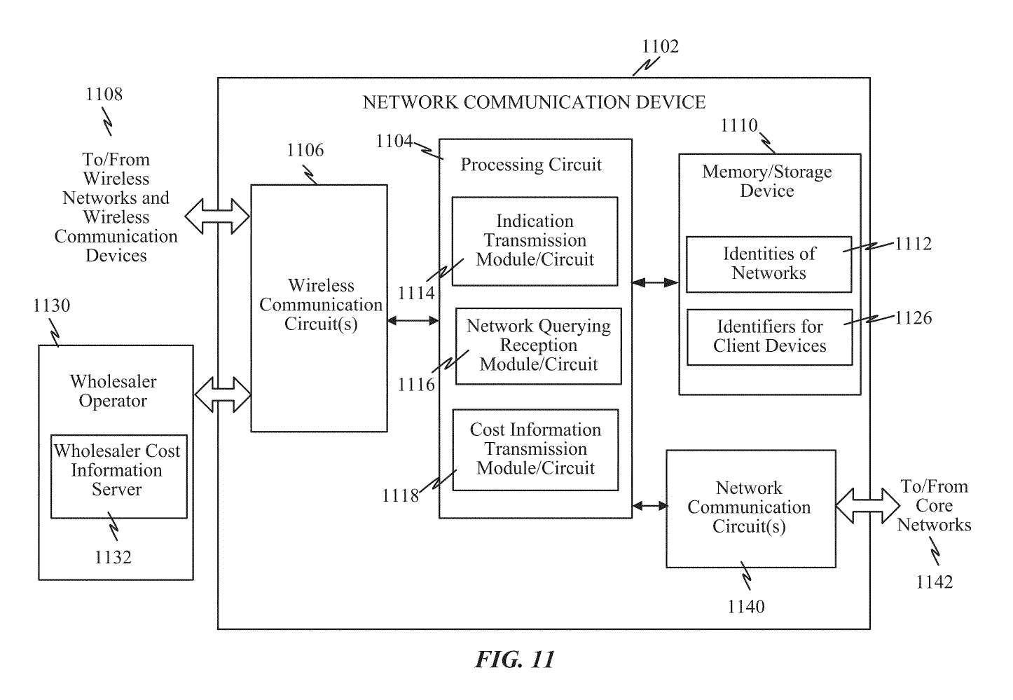

FIG. 11 is a block diagram illustrating a network communication device 1102. The network communication device 1102 may include a processing circuit 1104 coupled to a wireless communication circuit 1106, a memory/storage device 1110, and a network communication circuit 1140. The wireless communication circuit 1106 may facilitate wireless communications over two or more distinct wireless networks 1108 or wireless communication devices, such as an operator 1130, which includes a cost information server 1132. The network communication circuit 1140 may facilitate data communications to and/or from one or more core networks 1142. The network communication device 1102 may be, a network node, an access point, or an eNB (Evolved Universal Terrestrial Radio Access Network (E-UTRAN) Node B, or evolved Node B), for example.

The processing circuit 1104 may include or implement an indication transmission module/circuit 1114 that permits the network communication device 1102 to send a first indication of an identity of a network and also send a second indication of whether cost information associated with the network is available.

The processing circuit 1104 may also include or implement a network querying reception module/circuit 1116 that permits the network communication device 1102 to receive a query to the network for the cost information if the second indication indicates that the cost information is available.

The processing circuit 1104 may also include or implement a cost information transmission module/circuit 1118 that permits the network communication device 1102 to send the cost information associated with the network. The network communication device 1102 also contains a memory/storage device 1110, which stores identities of networks 1112 and identifiers for client devices 1126. The identities of networks 1112 store identities of various networks that are retrieved when the first indication of an identity of a network is sent. The identifiers for client devices 1126 are described above in the description of the identifiers for client devices 1012 in FIG. 10.

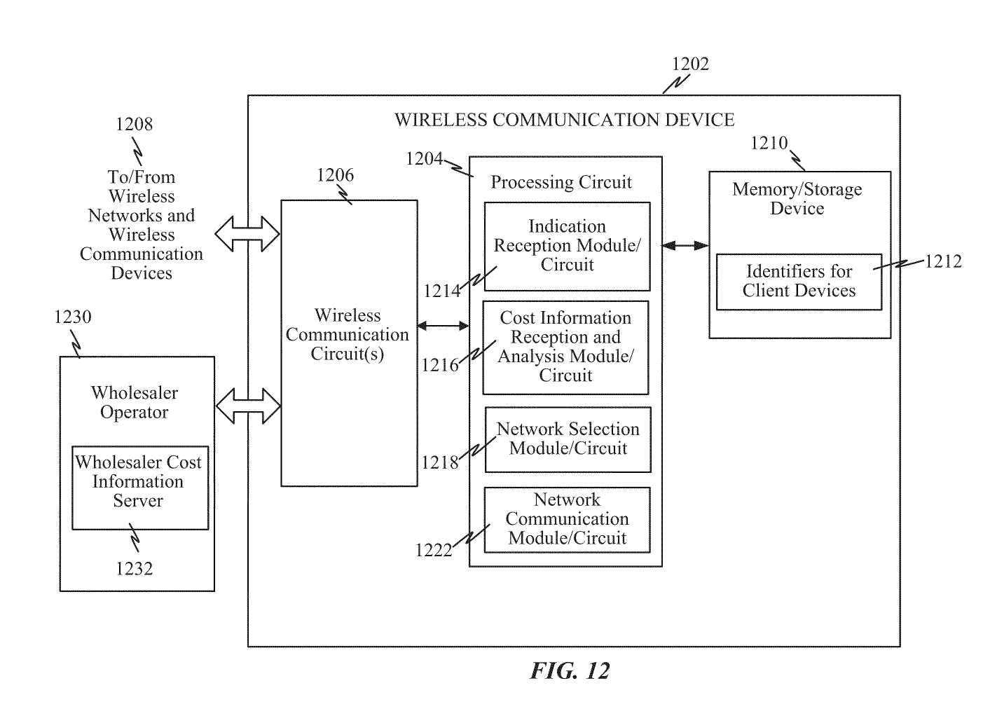

FIG. 12 is a block diagram illustrating a wireless communication device 1202. The wireless communication device 1202 may include a processing circuit 1204 coupled to a wireless communication circuit 1206, and a memory/storage device 1210. The wireless communication circuit 1206 may facilitate wireless communications over two or more distinct wireless networks 1208 or wireless communication devices, such as an operator 1230, which includes a cost information server 1232. The wireless communication device 1202 may be a mobile device, or user device, or user equipment (UE), for example.

The processing circuit 1204 may include or implement an indication reception module/circuit 1214 that permits the wireless communication device 1202 to receive a first indication of an identity of a network.

The processing circuit 1204 may also include or implement a cost information reception and analysis module/circuit 1216 that permits the wireless communication device 1202 to receive the cost information associated with the network. The cost information also includes at least one or more of cost information for a high-level application or cost information for a location where service charging may occur.

The processing circuit 1204 may also include or implement a network selection module/circuit 1218 that permits the wireless communication device 1202 to select the network based on the received cost information.

The processing circuit 1204 may also include or implement a network communication module/circuit 1222 that permits the wireless communication device 1202 to communicate via the selected network.

The wireless communication device 1202 also contains a memory/storage device 1210, which stores identifiers for client devices 1212. The identifiers for client devices 1212 are described above in the description of the identifiers for client devices 1012 in FIG. 10.

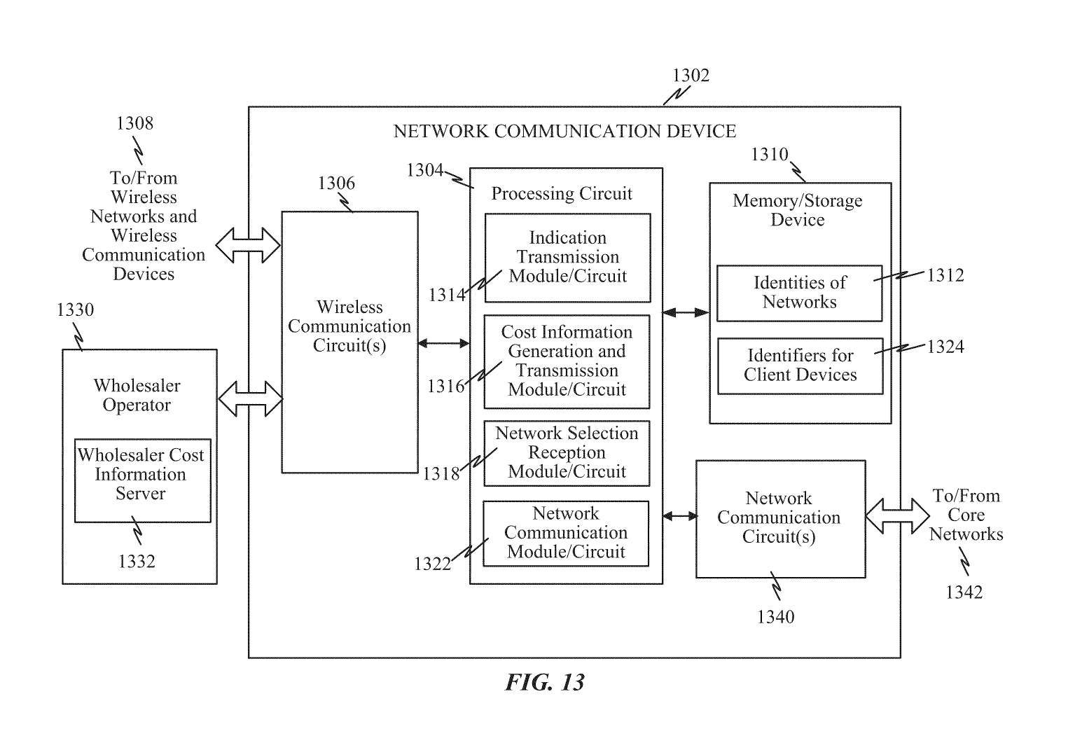

FIG. 13 is a block diagram illustrating a network communication device 1302. The network communication device 1302 may include a processing circuit 1304 coupled to a wireless communication circuit 1306, a memory/storage device 1310, and a network communication circuit 1340. The wireless communication circuit 1306 may facilitate wireless communications over two or more distinct wireless networks 1308 or wireless communication devices, such as an operator 1330, which includes a cost information server 1332. The network communication circuit 1340 may facilitate data communications to and/or from one or more core networks 1342. The network communication device 1302 may be a network node, an access point, or an eNB, for example.

The processing circuit 1304 may include or implement an indication transmission module/circuit 1314 that permits the network communication device 1302 to send a first indication of an identity of a network

The processing circuit 1304 may also include or implement a cost information generation and transmission module/circuit 1316 that permits the network communication device 1302 to generate the cost information in response to receiving the query and also send the cost information associated with the network. The cost information also includes at least one or more of cost information for a high-level application or cost information for a location where service charging may occur.

The processing circuit 1304 may also include or implement a network selection reception module/circuit 1318 that permits the network communication device 1302 to receive a selection of the network based on the sent cost information.

The processing circuit 1304 may also include or implement a network communication module/circuit 1322 that permits the network communication device 1302 to communicate via the selected network.

The network communication device 1302 also contains a memory/storage device 1310, which stores identities of networks 1312 and identifiers for client devices 1324. The identities of networks 1312 are described above in the description for the identities of networks 1112 in FIG. 11. The identifiers for client devices 1324 are also described above in the description of the identifiers for client devices 1012 in FIG. 10.

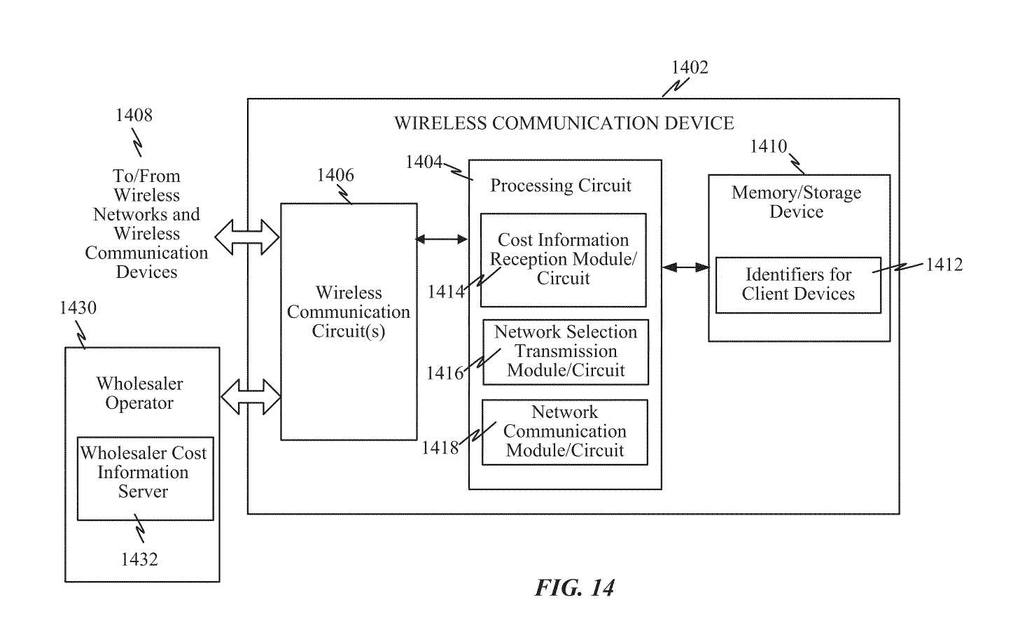

FIG. 14 is a block diagram illustrating a wireless communication device 1402. The wireless communication device 1402 may include a processing circuit 1404 coupled to a wireless communication circuit 1406, and a memory/storage device 1410. The wireless communication circuit 1406 may facilitate wireless communications over two or more distinct wireless networks 1408 or wireless communication devices, such as an operator 1430, which includes a cost information server 1432. The wireless communication device 1402 may be a mobile device, or user device, or user equipment (UE), for example.

The processing circuit 1404 may include or implement a cost information reception module/circuit 1414 that permits the wireless communication device 1402 to receive an identification of the cost information associated with it and/or at least one network. The cost information is indicative of at least one cost of communicating data via the at least one network. In one implementation, the cost information reception module/circuit 1414 receives an identification of cost information from the network, for example.

The processing circuit 1404 may also include or implement a network selection transmission module/circuit 1416 that permits the wireless communication device 1402 to select a network from the at least one network, the selection being based on the cost information, and then transmit that selection to the network.

The processing circuit 1404 may also include or implement a network communication module/circuit 1418 that permits the wireless communication device 1402 to communicate via the selected network.

The wireless communication device 1402 also contains a memory/storage device 1410, which stores identifiers for client devices 1412. The identifiers for client devices 1412 are also described above in the description of the identifiers for client devices 1012 in FIG. 10.

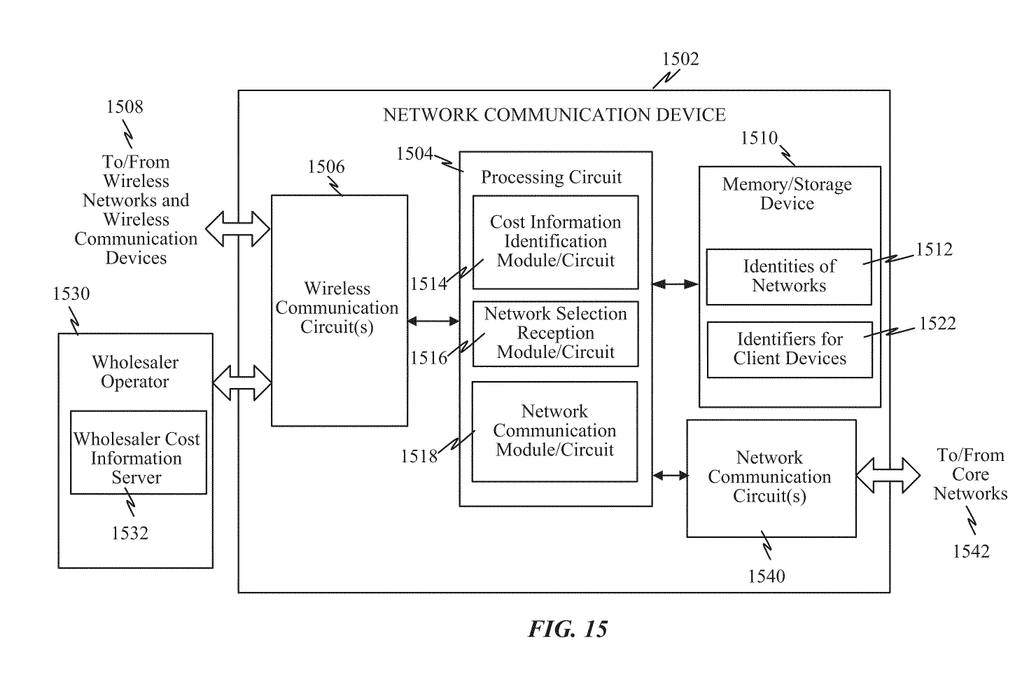

FIG. 15 is a block diagram illustrating a network communication device 1502. The network communication device 1502 may include a processing circuit 1504 coupled to a wireless communication circuit 1506, a memory/storage device 1510, and a network communication circuit 1540. The wireless communication circuit 1506 may facilitate wireless communications over two or more distinct wireless networks 1508 or wireless communication devices, such as an operator 1530, which includes a cost information server 1532. The network communication circuit 1540 may facilitate data communications to and/or from one or more core networks 1542. The network communication device 1502 may be a network node, an access point, or an eNB, for example.

The processing circuit 1504 may also include or implement a cost information identification module/circuit 1514 that permits the network communication device 1502 to provide the identification of cost information associated with at least one network and a user device. The cost information is indicative of at least one cost of communicating data via the at least one network. In one implementation, the identification of the cost information associated with the network is performed at the network communication device 1502, without any identification having to be performed at the wireless communication device 1402 of FIG. 14.

The processing circuit 1504 may also include or implement a network selection reception module/circuit 1516 that permits the network communication device 1502 to receive a selection of a network from at least one network from the user device or the wireless communication device 1402 of FIG. 14, the selection being based on the cost information. In one implementation, the selection of the network may be performed at the network communication device 1502, without any selection having to be performed at the wireless communication device 1402 of FIG. 14.

The processing circuit 1504 may also include or implement a network communication module/circuit 1518 that permits the network communication device 1502 to communicate via the selected network, selected by the network selection reception module/circuit 1516.

The network communication device 1502 also contains a memory/storage device 1510, which stores identities of networks 1512 and identifiers for client devices 1522. The identities of networks 1512 are described above in the description for the identities of networks 1112 in FIG. 11. The identifiers for client devices 1522 are also described above in the description of the identifiers for client devices 1012 in FIG. 10.

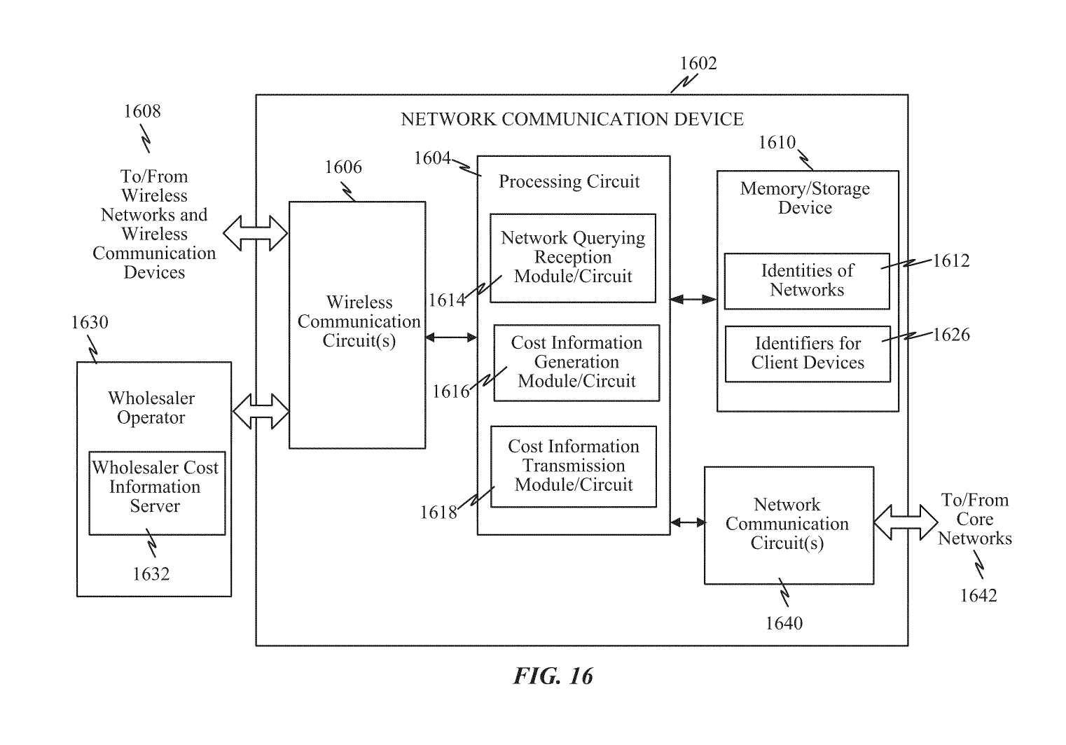

FIG. 16 is a block diagram illustrating a network communication device 1602. The network communication device 1602 may include a processing circuit 1604 coupled to a wireless communication circuit 1606, a memory/storage device 1610, and a network communication circuit 1640. The wireless communication circuit 1606 may facilitate wireless communications over two or more distinct wireless networks 1608 or wireless communication devices, such as an operator 1630, which includes a cost information server 1632. The network communication circuit 1640 may facilitate data communications to and/or from one or more core networks 1642. The network communication device 1602 may be, a network node, an access point, or an eNB (Evolved Universal Terrestrial Radio Access Network (E-UTRAN) Node B, or evolved Node B), for example.

The processing circuit 1604 may also include or implement a network querying reception module/circuit 1614 that permits the network communication device 1602 to receive a query to the network for the cost information associated with the network.

The processing circuit 1604 may also include or implement a cost information generation module/circuit 1616 that permits the network communication device 1602 to generate the cost information in response to receiving the query.

The processing circuit 1604 may also include or implement a cost information transmission module/circuit 1618 that permits the network communication device 1602 to send the cost information associated with the network. The cost information also includes at least two or more of: a first cost information for an access technology; a second cost information for a wireless spectrum; a third cost information for a subscription; a fourth cost information for a high-level application; a fifth cost information for a service class; a sixth cost information for a location where service charging may occur; a seventh cost information for particular traffic; an eighth cost information for a time of day; a ninth cost information for a first load of a particular cell; a tenth cost information for a second load of a base station; or an eleventh cost information for a dynamic entity.

The network communication device 1602 also contains a memory/storage device 1610, which stores identities of networks 1612 and identifiers for client devices 1626. The identities of networks 1612 store identities of various networks that are retrieved when the first indication of an identity of a network is sent. The identifiers for client devices 1626 are described above in the description of the identifiers for client devices 1012 in FIG. 10.

The operator(s) 1030, 1130, 1230, 1330, 1430, 1530 and 1630 of the above corresponding devices 1002, 1102, 1202, 1302, 1402, 1502 and 1602 (see FIGS. 10-16) may also be coupled, wirelessly, directly or otherwise, to the wireless communication circuit(s) 1006, 1106, 1206, 1306, 1406, 1506 and 1606 of the corresponding devices 1002, 1102, 1202, 1302, 1402, 1502 and 1602 in FIGS. 10-16.

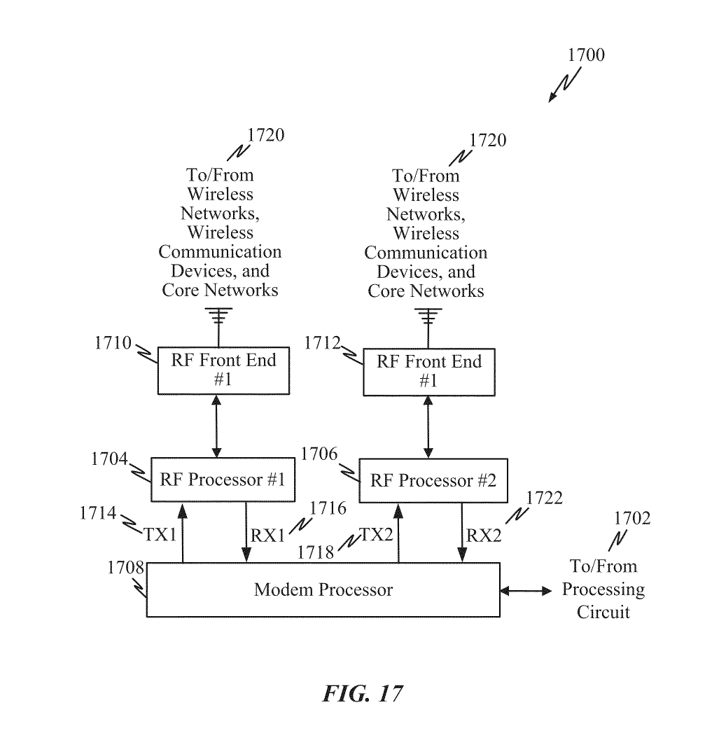

FIG. 17 is a block diagram illustrating an example of the wireless communication circuit 1700 (e.g., wireless communication circuits 1006, 1106, 1206, 1306, 1406, 1506, and 1606) of the devices 1002, 1102, 1202, 1302, 1402, 1502 and 1602. For simplicity, the wireless communication circuit will be referred to as wireless communication circuit 1700 in FIG. 17. In the example of FIG. 17, at least one transceiver chain may be implemented. In this case, two transceiver chains that can be concurrently active are shown and implemented. A first transceiver chain may include a first radio frequency (RF) processor 1704 and a first RF front end interface 1710. A second transceiver chain may include a second RF processor 1706 and a second RF front end interface 1712. Furthermore, the first and second RF processor 1704 and 1706 may be coupled to the first RF front end interface 1710 and the second RF front end interface 1712, respectively. Both the first and second RF processors 1704 and 1706 may be coupled to a modem processor 1708. The modem processor 1708 transmits a first transmitted signal 1714 to the first RF processor 1704 and a second transmitted signal 1718 to the second RF processor 1706. The modem processor 1708 also receives a first received signal 1716 from the first RF processor 1704 and a second received signal 1722 from the second RF processor 1706. The to/from processing circuit area 1702 leads from the modem processor 1708 to the processing circuits 1004, 1104, 1204, 1304, 1404, 1504 and 1604 of a given wireless communication device or network communication device from the devices 1002, 1102, 1202, 1302, 1402, 1502 and 1602. The antennae from the first RF front end interface 1710 and the second RF front end interface 1712 lead to/from wireless networks and wireless communication devices and core networks or at least one core network 1720. Examples of the wireless communication devices include the wholesale operators 1030, 1130, 1230, 1330, 1430, 1530 and 1630.

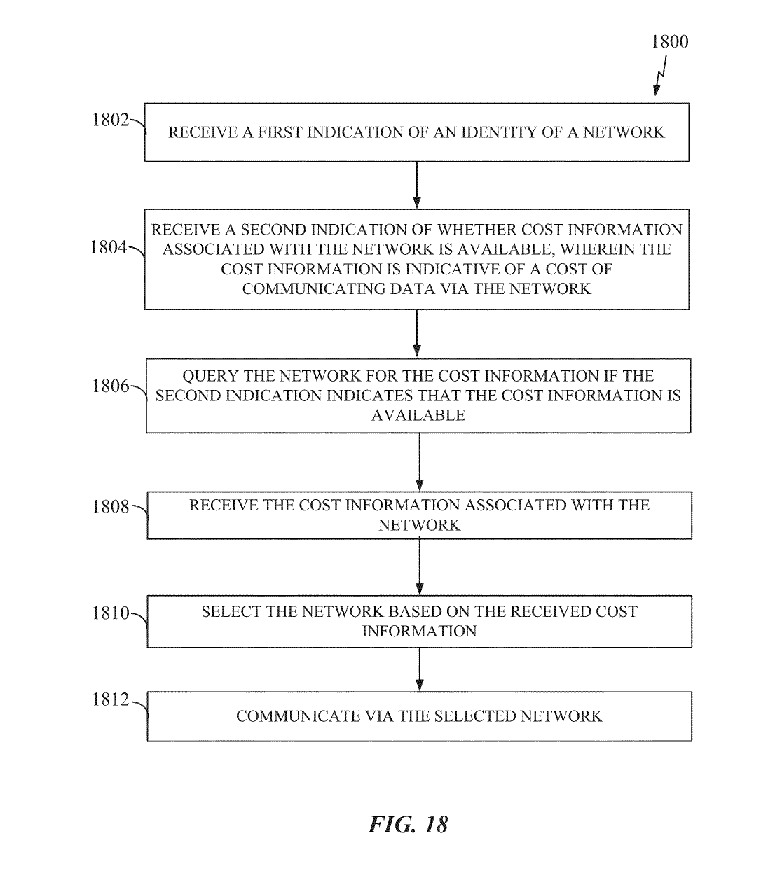

FIGS. 10-16 are block diagrams illustrating example hardware implementations for wireless communication devices and network communication devices that execute any of the methods described herein, specifically in FIGS. 18-24. For example, the devices 1002, 1102, 1202, 1302, 1402, 1502 and 1602 could embody a mobile device, a network node, an access point, or some other type of device. The devices 1002, 1102, 1202, 1302, 1402, 1502 and 1602 may also be a mobile phone, a smart phone, a tablet, a portable computer, a server, a personal computer, and or any other electronic device having circuitry.

The devices 1002, 1102, 1202, 1302, 1402, 1502 and 1602 may also include a communication interface, a user interface, and a system. The system may include a processing circuit (e.g., processor), a memory (e.g., memory circuit), a computer-readable storage medium, a bus interface, and a bus. The system and/or the processing circuit may be configured to perform any of the steps, functions, and/or processes described with respect to FIGS. 1-9 and 18-24.

The processing circuit, which may be similar to the processing circuits 1004, 1104, 1204, 1304, 1404, 1504 and 1604 may also be one or more processors (e.g., first processor, etc.) that are adapted to process data. For example, each of the processing circuits 1004, 1104, 1204, 1304, 1404, 1504 and 1604 may be a specialized processor, such as an application specific integrated circuit (ASIC) that serves as a means for carrying out any one of the operations described in FIGS. 1-9 and 18-24. The processing circuits 1004, 1104, 1204, 1304, 1404, 1504 and 1604 serve as examples of a means for the various process steps described in FIGS. 18-24.

Examples of the processing circuits 1004, 1104, 1204, 1304, 1404, 1504 and 1604 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. The processing circuits 1004, 1104, 1204, 1304, 1404, 1504 and 1604 may also be responsible for managing the bus, and executing software stored on the computer-readable storage medium and/or memory. The software, when executed by the processing circuits 1004, 1104, 1204, 1304, 1404, 1504 and 1604 causes the system to perform the various functions, steps, and/or processes described above with respect to FIGS. 1-9 and 18-24. The computer-readable storage medium may be used for storing data that is manipulated by the processing circuits 1004, 1104, 1204, 1304, 1404, 1504 and 1604 when executing software.

The memory/storage devices 1010, 1110, 1210, 1310, 1410, 1510 and 1610 may be non-volatile memory, such as but not limited to FLASH memory, magnetic or optical hard disk drives, etc. In some aspects, the memory may be volatile memory, such as dynamic random access memory (DRAM) (e.g., DDR SDRAM), SRAM, etc., that may be continuously powered so as to store the information indefinitely.

Software or instructions shall be construed broadly to mean software, instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable storage medium. The computer-readable storage medium may be a non-transitory computer-readable storage medium. A non-transitory computer-readable storage medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable storage medium may reside in the system, external to the system, or distributed across a plurality of entities including the system. The computer-readable storage medium may be embodied in a computer program product. Also, the various devices described above could interface with a computer-readable medium that could include, by way of example, a carrier wave, a transmission line, and any other suitable medium for transmitting software and/or instructions that may be accessed and read by a computer.

The system may also be implemented with a bus architecture, represented generally by the bus. The bus may include any number of interconnecting buses and bridges depending on the specific application of the system and the overall design constraints. The bus links together various circuits including one or more processors (represented generally by the processor), the memory, and computer-readable media (represented generally by the computer-readable storage medium). The bus may also link various other circuits such as timing sources, peripherals, voltage regulators, and power management circuits, which are well known in the art, and therefore, will not be described any further. A bus interface provides an interface between the bus and the communication interface (if present). The bus interface serves as one example of a means for receiving and/or transmitting. The communication interface provides a means for communicating with other apparatuses over a transmission medium. The communication interface serves as one example of a means for receiving and/or transmitting. Depending upon the nature of the apparatus, a user interface (e.g., keypad, display, speaker, microphone, touchscreen display, etc.) may also be provided for the overall device.

FIG. 18 illustrates a process 1800 for receiving cost information in accordance with some aspects of the disclosure. The process 1800 may take place within a processing circuit (e.g., processing circuits 1004, 1104, 1204, 1304, 1404, 1504 and 1604) of a wireless communication device (e.g., the wireless communication devices 1002, 1202, 1402 in the above FIGS. 10, 12 and 14, respectively), the wireless communication device storing the processing circuit may also be a mobile device, a user device, a user equipment (UE), or some other suitable apparatus. Of course, in various aspects within the scope of the disclosure, the process 1800 may be implemented by any suitable apparatus capable of supporting cost signaling operations.

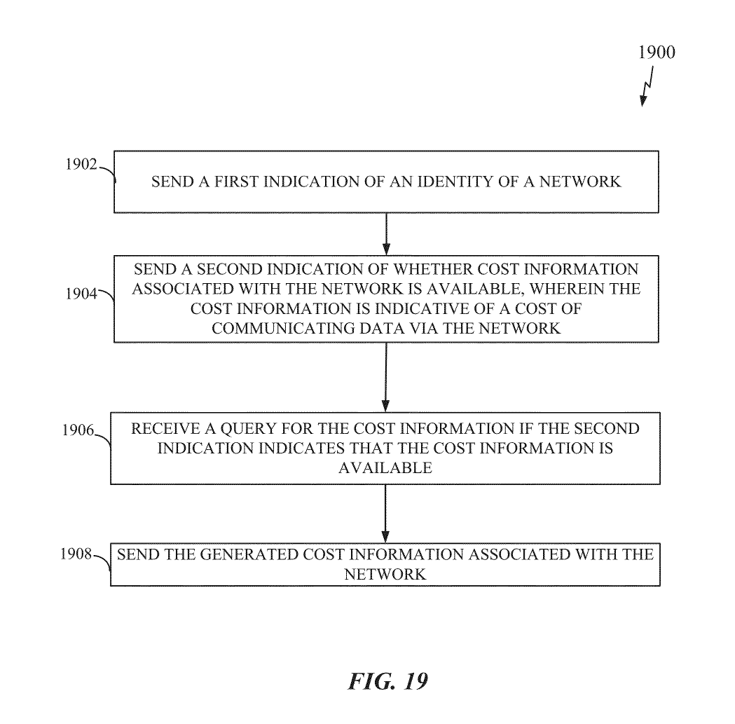

A first indication of an identity of a network is received 1802. A second indication of whether cost information associated with the network is available is received 1804. The cost information is indicative of a cost of communicating data via the network. The network is queried for the cost information if the second indication indicates that the cost information is available 1806. The cost information associated with the network is received 1808. As discussed in more detail below in conjunction with later FIGS. 19-24, a UE can use this received cost information to manage connectivity. A network is selected based on the received cost information 1810. Communication is performed via the selected network 1812.

A UE may receive the cost information and an associated network identifier in an information element. The UE may then receive signals from a nearby access point (e.g., eNB) and thereby discover the network identified by the indication for subsequent access.

According to one aspect, the cost information associated with the network is received as a result of receiving the second indication that the cost information is available. In another aspect, the second indication indicates a radio access network (RAN) advertises cost information or indicates the use of an over-the-top server. In one aspect, the cost of communicating data via the network includes a cost of establishing connectivity with the network. In one aspect, the process 1800 also includes invoking a mobility event, the cost information being received in conjunction with the invoking of the mobility event. In another aspect, the mobility event includes establishing connectivity with at least one network or modifying connectivity with at least one network, wherein the at least one network includes the network. In another aspect, the cost information includes receiving the cost information via broadcast signaling.

FIG. 19 illustrates a process 1900 for transmitting cost information in accordance with some aspects of the disclosure. The process 1900 may take place within a processing circuit (e.g., the processing circuit 1104 of FIG. 11), which may be located in a network communication device, a network node, an access point, an Evolved Universal Terrestrial Radio Access Network (E-UTRAN) Node B, or evolved Node B (eNB), or some other suitable apparatus. Of course, in various aspects within the scope of the disclosure, the process 1900 may be implemented by any suitable apparatus capable of supporting cost signaling operations.

A first indication of an identity of a network is sent 1902. A second indication of whether cost information associated with the network is available is sent 1904. The cost information is indicative of a cost of communicating data via the network. A query is received for the cost information if the second indication indicates that the cost information is available 1906. For example, in addition to the network, a cost information server may receive this query from a connection manager of a UE via a serving network for the UE.

The cost information associated with the network is sent 1908. For example, the cost information may be sent to a serving network (e.g., serving eNB) for the requesting UE.

In one aspect, cost information is generated in response to the receipt of the query. As discussed herein, this cost information may be generated based on various factors including, without limitation, associated subscriptions, traffic conditions, associated applications, or roaming status. The cost information may also be generated by retrieving the cost information data from the cost information server 1032, 1132, 1232, 1332, 1432, 1532 and 1632 (hereinafter the “cost information servers 1032-1532”) of the operators 1030, 1130, 1230, 1330, 1430, 1540 and 1640 as shown in FIGS. 10-16.

In one aspect, process 1900 also includes receiving a second indication of whether cost information associated with the network is available, and querying the network for the cost information if the second indication indicates that the cost information is available. The cost information associated with the network may be received as a result of receiving the second indication that the cost information is available.

In another aspect, the second indication indicates a radio access network (RAN) advertises cost information or indicates the use of an over-the-top server. In one aspect, the cost of communicating data via the network includes a cost of establishing connectivity with the network. In one aspect, the process 1900 also includes invoking a mobility event, the cost information being received in conjunction with the invoking of the mobility event. In another aspect, the mobility event includes establishing connectivity with at least one network or modifying connectivity with at least one network, wherein the at least one network includes the network. In another aspect, the cost information includes receiving the cost information via broadcast signaling.

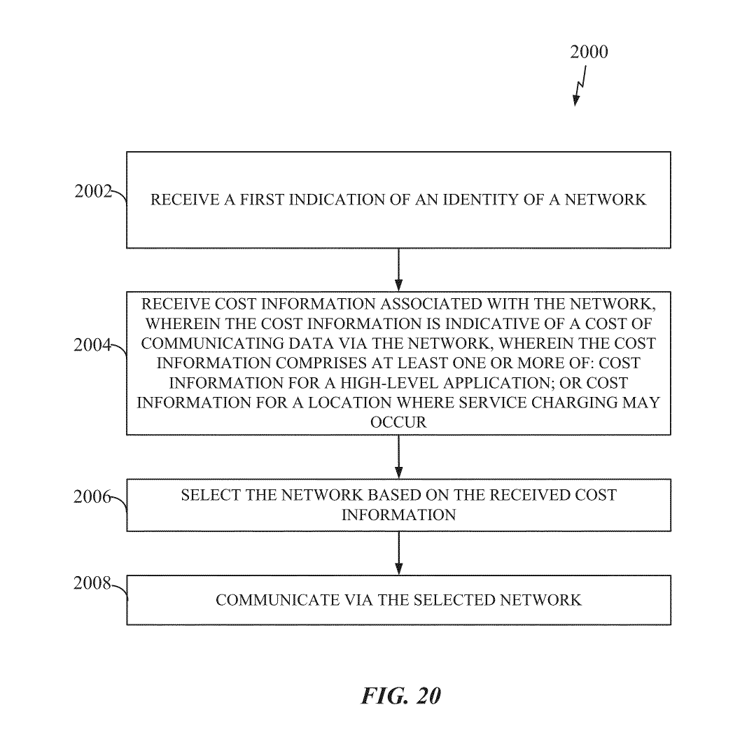

FIG. 20 illustrates a process 2000 for receiving cost information in accordance with some aspects of the disclosure. The process 2000 may take place within a processing circuit (e.g., the processing circuit 1204 of FIG. 12), which may be located in a wireless communication device, a mobile device, a user device, a user equipment (UE), or some other suitable apparatus. Of course, in various aspects within the scope of the disclosure, the process 2000 may be implemented by any suitable apparatus capable of supporting cost signaling operations.

A first indication of an identity of a network is received 2002. Cost information associated with the network is received 2004. As discussed herein, the cost information is indicative of a cost of communicating data via the network. The cost information includes at least one or more of: cost information for a high-level application or cost information for a location where service charging may occur. The high-level application may or may not have an application provider. The location where service charging may occur is where the user has to pay a service charge for using, for example, a mobile device. A network is selected based on the received cost information 2006. Communication is performed via the selected networks 2008.

According to one aspect, process 2000 further includes receiving a second indication of whether cost information associated with the network is available, and querying the network for the cost information if the second indication indicates that the cost information is available. The cost information associated with the network may be received as a result of receiving the second indication that the cost information is available.

In another aspect, the second indication indicates a radio access network (RAN) advertises cost information or indicates the use of an over-the-top server. In one aspect, the cost of communicating data via the network includes a cost of establishing connectivity with the network. In one aspect, the process 2000 also includes invoking a mobility event, the cost information being received in conjunction with the invoking of the mobility event. In another aspect, the mobility event includes establishing connectivity with at least one network or modifying connectivity with at least one network, wherein the at least one network includes the network. In another aspect, the cost information includes receiving the cost information via broadcast signaling.

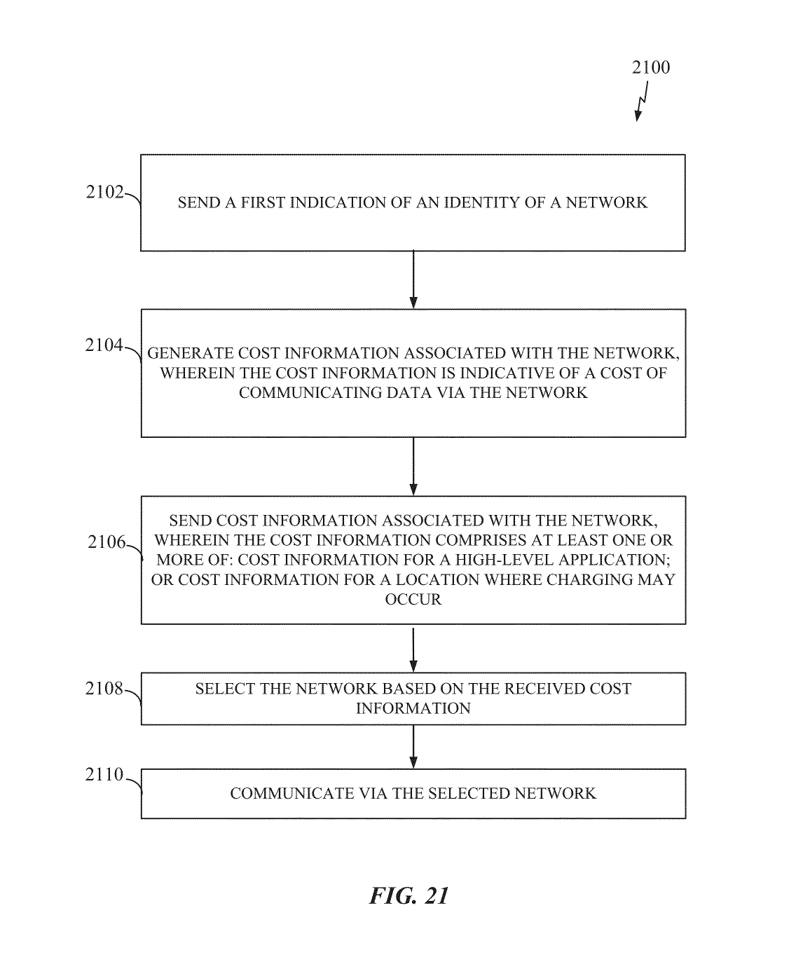

FIG. 21 illustrates a process 2100 for sending cost information in accordance with some aspects of the disclosure. The process 2100 may take place within a processing circuit (e.g., the processing circuit 1304 of FIG. 13), which may be located in a network communication device, a network node, an access point, an eNB, or some other suitable apparatus. Of course, in various aspects within the scope of the disclosure, the process 2100 may be implemented by any suitable apparatus capable of supporting cost signaling operations.

A first indication of an identity of a network is sent 2102. The cost information associated with the network is generated 2104. This cost information may be generated based on various factors including, without limitation, associated subscriptions, traffic conditions, associated applications, or roaming status. The cost information may also be generated by retrieving the cost information data from the cost information servers 1032, 1131, 1232, 1332, 1432, 1532 and 1632 of the operators 1030, 1130, 1230, 1330, 1430, 1530 and 1630 as shown in FIGS. 10-16. As discussed herein, the cost information is indicative of a cost of communicating data via the network.

The cost information associated with the network is sent 2106. The cost information includes at least one or more of: cost information for a high-level application, or cost information for a location where charging may occur. A network is selected based on the received cost information 2108. Communication is performed via the selected network 2110.

In one aspect, the process 2100 also includes receiving a second indication of whether cost information associated with the network is available, and querying the network for the cost information if the second indication indicates that the cost information is available, the cost information associated with the network being received as a result of receiving the second indication that the cost information is available.

In another aspect, the second indication indicates a radio access network (RAN) advertises cost information or indicates the use of an over-the-top server. In one aspect, the cost of communicating data via the network includes a cost of establishing connectivity with the network. In one aspect, the process 2100 also includes invoking a mobility event, the cost information being received in conjunction with the invoking of the mobility event. In another aspect, the mobility event includes establishing connectivity with at least one network or modifying connectivity with at least one network, wherein the at least one network includes the network. In another aspect, the cost information includes receiving the cost information via broadcast signaling.

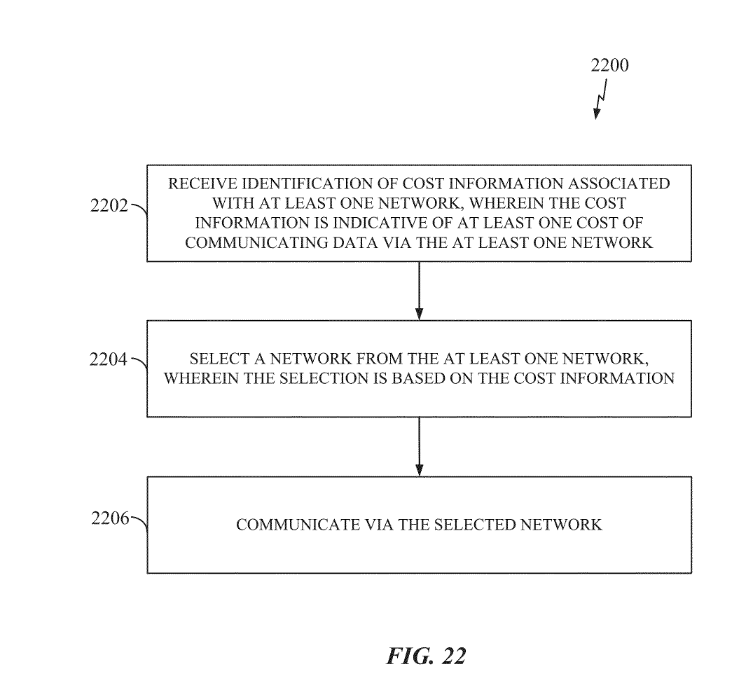

FIG. 22 illustrates a process 2200 for managing connectivity based on cost information in accordance with some aspects of the disclosure. The process 2200 may take place within a processing circuit (e.g., the processing circuit 1404 of FIG. 14), which may be located in a wireless communication device, a mobile device, a user device, a user equipment (UE), or some other suitable apparatus. Of course, in various aspects within the scope of the disclosure, the process 2200 may be implemented by any suitable apparatus capable of supporting connectivity operations.

Identification of cost information associated with at least one network is received 2202. For example, previously received cost information may be retrieved from a memory location. As discussed herein, the cost information is indicative of at least one cost of communicating data via the at least one network. In one implementation, the cost information may be received after retrieving it from the network, or from an external source such as any of the cost information servers 1032, 1131, 1232, 1332, 1432, 1532 and 1632 of any of the operators 1030, 1130, 1230, 1330, 1430, 1530 and 1630 as shown in FIGS. 10-16.

A network is selected from the at least one network 2204. This selection is based on the cost information. For example, a network that provides the highest level of service for the lowest cost may be selected. As discussed herein, the selection may be made by a connection manager, with or without input from a user.

Communication is conducted or performed via the selected network 2206. For example, a mobile device may use the selected network to access a particular application. This application may be, for example, associated with the advertized cost for the network access.

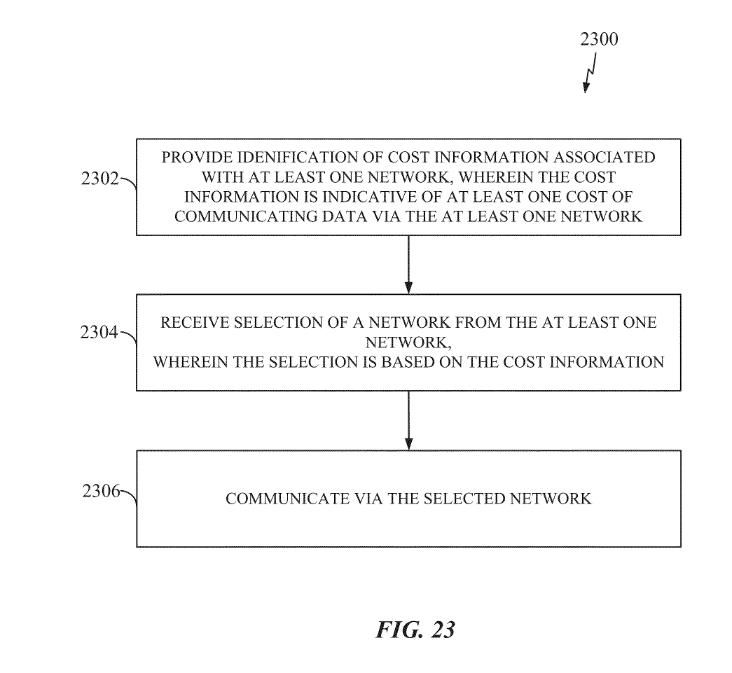

FIG. 23 illustrates a process 2300 for managing connectivity based on cost information in accordance with some aspects of the disclosure. The process 2300 may take place within a processing circuit (e.g., the processing circuit 1504 of FIG. 15), which may be located in a network communication device, network node, an access point, an eNB, or some other suitable apparatus. Of course, in various aspects within the scope of the disclosure, the process 2300 may be implemented by any suitable apparatus capable of supporting connectivity operations.

Cost information associated with at least one network is identified and provided 2302. For example, previously received cost information may be retrieved and identified from a memory or storage device location on a network or for example, the cost information servers 1032, 1131, 1232, 1332, 1432, 1532 and 1632 of the operator s1030, 1130, 1230, 1330, 1430, 1530 and 1630 as shown in FIGS. 10-16, and then provided to a user device or UE, for example. As discussed herein, the cost information is indicative of at least one cost of communicating data via the at least one network.

A selection of a network is received from the at least one network 2304. This selection is based on the cost information. In one implementation, the selection is alternatively made by a user device or UE, for example, and received by a network node or access point. A network that provides the highest level of service for the lowest cost may be selected. As discussed herein, the selection may be made by a connection manager, with or without input from a user.

Communication is conducted or performed via the selected network 2306. For example, a user device may use the selected network to access a particular application. A network node or access point can also use the selected network to access other objects. This application may be, for example, associated with the advertized cost for the network access.

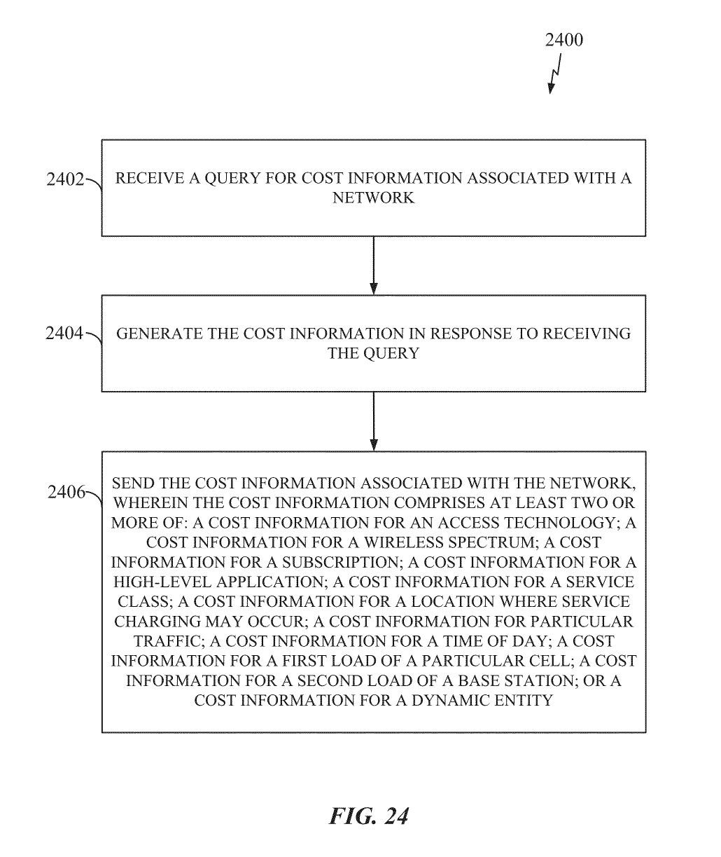

FIG. 24 illustrates a process for generating and transmitting cost information in accordance with some aspects of the disclosure. The process 2400 may take place within a processing circuit (e.g., the processing circuit 1604 of FIG. 16), which may be located in a network communication device, a network node, an access point, an Evolved Universal Terrestrial Radio Access Network (E-UTRAN) Node B, or evolved Node B (eNB), or some other suitable apparatus. Of course, in various aspects within the scope of the disclosure, the process 2400 may be implemented by any suitable apparatus capable of supporting cost signaling operations.

A query for cost information associated with a network is received 2402. The cost information is indicative of a cost of communicating data via the network.

Cost information is generated in response to the receipt of the query 2404. As discussed herein, this cost information may be generated based on various factors including, without limitation, associated subscriptions, traffic conditions, associated applications, or roaming status. The cost information may also be generated by retrieving the cost information data from the cost information server 1032, 1132, 1232, 1332, 1432, 1532, 1632 (hereinafter the “cost information servers 1032-1632”) of the operators 1030, 1130, 1230, 1330, 1430, 1540, 1640 as shown in FIGS. 10-16.

The cost information associated with the network is sent 2406. For example, the cost information may be sent to a serving network (e.g., serving eNB) for the requesting UE. The cost information also includes at least two or more of: a first cost information for an access technology; a second cost information for a wireless spectrum; a third cost information for a subscription; a fourth cost information for a high-level application; a fifth cost information for a service class; a sixth cost information for a location where service charging may occur; a seventh cost information for particular traffic; an eighth cost information for a time of day; a ninth cost information for a first load of a particular cell; a tenth cost information for a second load of a base station; or an eleventh cost information for a dynamic entity.

### Operators & Cost Information Servers

Provided in this present disclosure is the concept of an operator, which includes a cost information server. In one aspect, the operator can be known as a wholesaler operator, and the cost information server can also be known as a wholesaler cost information server because they act like wholesale vendors. The operators 1030, 1130, 1230, 1330, 1430, 1530 and 1630 each comprising a corresponding cost information server 1032, 1132, 1232, 1332, 1432, 1532 and 1632 can be seen in FIGS. 10-16. The operator (which can be an internet service provider, connectivity provider) maintains a plurality of cost information arrangements with a plurality of networks. The wholesale operator also signs the cost information using a certificate, so that when the cost information is received by a device (e.g., a mobile device) so that the device owner can ensure that the cost information is valid.

The operator also includes a least one cost information server for the cost information associated with the network. The cost information server stores a plurality cost information arrangements with a plurality of networks, including the cost information associated with the particular network that a user device is trying to connect to.

In the context of the cost information server, sending the request includes sending an identifier to the mobile device and/or a sub-identifier of a process on a device to the cost information server. The cost information may not be connected to a mobile device alone and can be connected to, encoded on, or stored on an application on any device or connected to, encoded on or stored on a virtual machine of any device. Therefore, the term sub-identifier of a process on a device covers those scenarios and also other scenarios that are not limited to just a device or mobile device. The identifiers are used to obtain cost information specific to the mobile device and the process on the device, and the cost information server includes cost information for a plurality of mobile devices, a plurality of processes on the device and multiple devices, including the mobile device and the process on the device (e.g., applications, virtual machines), associated with the plurality of networks having a plurality of cost information arrangements stored within the cost information server.

One or more of the components, steps, features, and/or functions illustrated in the Figures may be rearranged and/or combined into a single component, step, feature, or function or embodied in several components, steps, or functions. Additional

One or more of the components, steps, features, and/or functions illustrated in the Figures may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in the Figures may be configured to perform one or more of the methods, features, or steps described in the Figures. The novel algorithms described herein may also be efficiently implemented in software and/or embedded in hardware.

In addition, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read only memory (ROM), random access memory (RAM), magnetic disk storage mediums, optical storage mediums, flash memory devices, and/or other machine readable mediums for storing information. The term “machine readable medium” includes, but is not limited to portable or fixed storage devices, optical storage devices, wireless channels and various other mediums capable of storing, containing, or carrying instruction(s) and/or data.

Furthermore, embodiments may be implemented by hardware, software, firmware, middleware, microcode, or any combination thereof. When implemented in software, firmware, middleware, or microcode, the program code or code segments to perform the necessary tasks may be stored in a machine-readable medium such as a storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The various illustrative logical blocks, modules, circuits, elements, and/or components described in connection with the examples disclosed herein may be implemented or performed with a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing components, e.g., a combination of a DSP and a microprocessor, a number of microprocessors, one or more microprocessors in conjunction with a DSP core, or any other such configuration.

The methods or algorithms described in connection with the examples disclosed herein may be embodied directly in hardware, in a software module executable by a processor, or in a combination of both, in the form of processing unit, programming instructions, or other directions, and may be contained in a single device or distributed across a plurality of devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features described herein can be implemented in different systems without departing from the novel aspects described herein. It should be noted that the foregoing embodiments are merely examples and are not to be construed as limiting the claimed invention(s). The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method operable at a wireless communication device for cost signaling, comprising:
receiving a first indication of an identity of a network;
receiving a second indication of whether a cost information associated with the network is available, wherein the cost information is indicative of a cost of communicating data via the network;
querying the network for the cost information if the second indication indicates that the cost information is available;
receiving the cost information associated with the network;
selecting the network based on the received cost information; and
communicating via the selected network.

2. The method of claim 1, wherein querying the network for the cost information comprises sending a request to a cost information server for the cost information associated with the network, wherein the cost information server stores a plurality of cost information arrangements with a plurality of networks including the network.

3. The method of claim 2, wherein the sending of the request comprises sending an identifier of a client device, the cost information server containing the cost information for a plurality of devices, including the client device, with relation to the plurality of networks, the client device including an application on the client device.

4. The method of claim 2, further comprising receiving the cost information associated with the network from an operator that comprises the cost information server, the operator having the plurality of cost information arrangements with the plurality of networks including the network.

5. The method of claim 4, wherein the operator signs the cost information using a certificate.

6. The method of claim 1, wherein the cost information associated with the network is received as a result of receiving the second indication that the cost information is available.

7. The method of claim 1, wherein the second indication indicates that a radio access network (RAN) advertises the cost information or indicates the use of an over-the-top server.

8. The method of claim 1, wherein the cost of communicating data via the network comprises a cost of establishing connectivity with the network.

9. The method of claim 1, further comprising invoking a mobility event, wherein the cost information is received in conjunction with the invoking of the mobility event.

10. The method of claim 9, wherein the mobility event comprises establishing connectivity with at least one network or modifying connectivity with the at least one network, the at least one network including the network.

11. The method of claim 1, wherein receiving the cost information comprises receiving the cost information via broadcast signaling.

12. The method of claim 1, wherein the cost information comprises at least two or more of:
a first cost information for an access technology;
a second cost information for a wireless spectrum;
a third cost information for a subscription;
a fourth cost information for a high-level application;
a fifth cost information for a service class;
a sixth cost information for a location where service charging may occur;
a seventh cost information for particular traffic;
an eighth cost information for a time of day;
a ninth cost information for a first load of a particular cell;
a tenth cost information for a second load of a base station; or
an eleventh cost information for a dynamic entity.

13. The method of claim 12, wherein:
the wireless spectrum comprises a licensed spectrum, an unlicensed spectrum, or a shared access spectrum;
the subscription comprises a home subscription or a roaming subscription;
the location where service charging may occur is associated with a geographic location, a network identifier, a public land mobile network (PLMN), a tracking area, a cell identifier, or a service set identifier (SSID);
the time of day comprises a daytime, an afternoon, or an evening;
the particular cell comprises a serving cell or a non-serving cell;
the base station comprises a serving base station or a non-serving base station; and
the dynamic entity comprises an entity that changes frequently so that the cost information is calculated for it dynamically.

14. The method of claim 1, wherein the cost information comprises at least one of: a first cost information indication of a free rate, a second cost information indication of a home rate, a third cost information indication of a roaming rate, a fourth cost information indication of time, or any combination thereof.

15. The method of claim 14, wherein the fourth cost information indication of time relates to at least one of:
a duration of activity;
a period of time;
a time of day;
an expiry timer;
a refresh time; or
any combination thereof.

16. A wireless communication device, comprising:
a wireless communication circuit adapted for communications with a network and other devices;
a processing circuit coupled to the wireless communication circuit, the processing circuit configured to:
receive a first indication of an identity of the network;
receive a second indication of whether a cost information associated with the network is available, wherein the cost information is indicative of a cost of communicating data via the network;
query the network for the cost information if the second indication indicates that the cost information is available;
receive the cost information associated with the network;
select the network based on the received cost information; and
communicate via the selected network.

17. The wireless communication device of claim 16 further comprising:
a storage device including identifiers for client devices.

18. The wireless communication device of claim 16, wherein the wireless communication circuit comprises:
at least one transceiver chain; and
a modem processor coupled to the processing circuit.

19. The wireless communication device of claim 18, wherein the at least one transceiver chain comprises:
a first transceiver chain including a first radio frequency (RF) front end interface and a first RF processor, the first RF front end interface being coupled to the first RF processor; and
a second transceiver chain including a second RF front end interface and a second RF processor, the second RF front end interface being coupled to the second RF processor, the first and second RF front end interfaces communicating with the network and other devices.

20. The wireless communication device of claim 19, wherein the modem processor sends a first transmitted signal to the first RF processor and a second transmitted signal to the second RF processor, and also receives a first received signal from the first RF processor and a second received signal from the second RF processor.

21. A method operable at a network communication device, comprising:
sending a first indication of an identity of a network;
sending a second indication of whether a cost information associated with the network is available, wherein the cost information is indicative of a cost of communicating data via the network;
receiving a query for the cost information if the second indication indicates that the cost information is available; and
sending the cost information associated with the network.

22. The method of claim 21, further comprising receiving a request to access a cost information server for the cost information associated with the network, wherein the cost information server stores a plurality of cost information arrangements with a plurality of networks including the network.

23. The method of claim 22, wherein the receiving of the request comprises receiving an identifier of a client device, the cost information server containing the cost information for a plurality of devices, including the client device, with relation to the plurality of networks, the client device including an application on the client device.

24. The method of claim 22, further comprising receiving the cost information associated with the network from an operator that comprises the cost information server, the operator having the plurality of cost information arrangements with the plurality of networks including the network.

25. The method of claim 24, wherein the operator signs the cost information using a certificate.

26. The method of claim 21, further comprising generating the cost information in response to receiving the query, the generating of the cost information being based on various factors including associated subscriptions, traffic conditions, associated applications, and/or roaming status.

27. The method of claim 21, wherein the cost information associated with the network is sent as a result of sending the second indication that the cost information is available.

28. The method of claim 21, further comprising invoking a mobility event, wherein the cost information is sent in conjunction with the invoking of the mobility event.

29. The method of claim 28, wherein the mobility event comprises establishing connectivity with at least one network or modifying connectivity with the at least one network, wherein the at least one network includes the network.

30. The method of claim 21, wherein sending the cost information comprises sending the cost information via broadcast signaling.

31. A network communication device, comprising:
a wireless communication circuit adapted for communications with a network and other devices;
a network communication circuit adapted for communications with at least one core network;
a processing circuit coupled to the wireless communication circuit and the network communication circuit, the processing circuit configured to:
send a first indication of an identity of the network;
send a second indication of whether a cost information associated with the network is available, wherein the cost information is indicative of a cost of communicating data via the network;
receive a query for the cost information if the second indication indicates that the cost information is available; and
send the cost information associated with the network.

32. The network communication device of claim 31 further comprising:
a storage device including identifiers for client devices and identities of networks.

33. The network communication device of claim 31, wherein the processing circuit configured to generate the cost information in response to receiving the query is further configured to generate the cost information based on various factors including associated subscriptions, traffic conditions, associated applications, and/or roaming status.

34. The network communication device of claim 33, wherein the network communication circuit comprises:
at least one transceiver chain; and
a modem processor coupled to the processing circuit, wherein the at least one transceiver chain comprises:
a first transceiver chain including a first radio frequency (RF) front end interface and a first RF processor, the first RF front end interface being coupled to the first RF processor; and
a second transceiver chain including a second RF front end interface and a second RF processor, the second RF front end interface being coupled to the second RF processor, the first and second RF front end interfaces communicating with at least one core network.

35. The network communication device of claim 34, wherein the modem processor sends a first transmitted signal to the first RF processor and a second transmitted signal to the second RF processor, and also receives a first received signal from the first RF processor and a second received signal from the second RF processor.

36. A method operable at a network communication device, comprising:
receiving a query for cost information associated with a network;
generating the cost information in response to receiving the query;
sending the cost information associated with the network, wherein the cost information comprises at least two or more of:
a first cost information for an access technology;
a second cost information for a wireless spectrum;
a third cost information for a subscription;
a fourth cost information for a high-level application;
a fifth cost information for a service class;
a sixth cost information for a location where service charging may occur;
a seventh cost information for particular traffic;
an eighth cost information for a time of day;
a ninth cost information for a first load of a particular cell;
a tenth cost information for a second load of a base station; or
an eleventh cost information for a dynamic entity.

37. An apparatus operable in a wireless communication device for cost signaling, comprising:
means for receiving a first indication of an identity of a network;
means for receiving a second indication of whether a cost information associated with the network is available, wherein the cost information is indicative of a cost of communicating data via the network;
means for querying the network for the cost information if the second indication indicates that the cost information is available;
means for receiving the cost information associated with the network;
means for selecting the network based on the received cost information; and
means for communicating via the selected network.

38. The apparatus of claim 37, wherein the means for querying the network for the cost information comprises means for sending a request to a cost information server for the cost information associated with the network, wherein the cost information server stores a plurality of cost information arrangements with a plurality of networks including the network.

39. The apparatus of claim 38, wherein the means for sending of the request comprises means for sending an identifier of a client device, the cost information server containing the cost information for a plurality of devices, including the client device, with relation to the plurality of networks, the client device including an application on the client device.

40. The apparatus of claim 38, further comprising means for receiving the cost information associated with the network from an operator that comprises the cost information server, the operator having the plurality of cost information arrangements with the plurality of networks including the network.

41. The apparatus of claim 40, wherein the operator signs the cost information using a certificate.

42. The apparatus of claim 37, wherein the cost information associated with the network is received as a result of receiving the second indication that the cost information is available.

43. The apparatus of claim 37, wherein the second indication indicates that a radio access network (RAN) advertises the cost information or indicates the use of an over-the-top server.

44. The apparatus of claim 37, wherein the cost of communicating data via the network comprises a cost of establishing connectivity with the network.

45. The apparatus of claim 37, further comprising means for invoking a mobility event, wherein the cost information is received in conjunction with the invoking of the mobility event.

46. The apparatus of claim 45, wherein the mobility event comprises establishing connectivity with at least one network or modifying connectivity with the at least one network, the at least one network including the network.

47. The apparatus of claim 37, wherein the means for receiving the cost information comprises means for receiving the cost information via broadcast signaling.

48. The apparatus of claim 37, wherein the cost information comprises at least two or more of:
a first cost information for an access technology;
a second cost information for a wireless spectrum;
a third cost information for a subscription;
a fourth cost information for a high-level application;
a fifth cost information for a service class;
a sixth cost information for a location where service charging may occur;
a seventh cost information for particular traffic;
an eighth cost information for a time of day;
a ninth cost information for a first load of a particular cell;
a tenth cost information for a second load of a base station; or
an eleventh cost information for a dynamic entity.

49. The apparatus of claim 48, wherein:
the wireless spectrum comprises a licensed spectrum, an unlicensed spectrum, or a shared access spectrum;
the subscription comprises a home subscription or a roaming subscription;
the location where service charging may occur is associated with a geographic location, a network identifier, a public land mobile network (PLMN), a tracking area, a cell identifier, or a service set identifier (SSID);
the time of day comprises a daytime, an afternoon, or an evening;
the particular cell comprises a serving cell or a non-serving cell;
the base station comprises a serving base station or a non-serving base station; and
the dynamic entity comprises an entity that changes frequently so that the cost information is calculated for it dynamically.

50. The apparatus of claim 37, wherein the cost information comprises at least one of: a first cost information indication of a free rate, a second cost information indication of a home rate, a third cost information indication of a roaming rate, a fourth cost information indication of time, or any combination thereof.

51. The apparatus of claim 50, wherein the fourth cost information indication of time relates to at least one of:
a duration of activity;
a period of time;
a time of day;
an expiry timer;
a refresh time; or
any combination thereof.

52. An apparatus operable in a network communication device, comprising:
means for sending a first indication of an identity of a network;
means for sending a second indication of whether a cost information associated with the network is available, wherein the cost information is indicative of a cost of communicating data via the network;
means for receiving a query for the cost information if the second indication indicates that the cost information is available; and
means for sending the cost information associated with the network.

53. The apparatus of claim 52, further comprising means for receiving a request to access a cost information server for the cost information associated with the network, wherein the cost information server stores a plurality of cost information arrangements with a plurality of networks including the network.

54. The apparatus of claim 53, wherein the means for receiving of the request comprises means for receiving an identifier of a client device, the cost information server containing the cost information for a plurality of devices, including the client device, with relation to the plurality of networks, the client device including an application on the client device.

55. The apparatus of claim 53, further comprising means for receiving the cost information associated with the network from an operator that comprises the cost information server, the operator having the plurality of cost information arrangements with the plurality of networks including the network.

56. The apparatus of claim 55, wherein the operator signs the cost information using a certificate.

57. The apparatus of claim 52, further comprising means for generating the cost information in response to receiving the query, the generating of the cost information being based on various factors including associated subscriptions, traffic conditions, associated applications, and/or roaming status.

58. The apparatus of claim 52, wherein the cost information associated with the network is sent as a result of sending the second indication that the cost information is available.

59. The apparatus of claim 52, further comprising means for invoking a mobility event, wherein the cost information is sent in conjunction with the invoking of the mobility event.

60. The apparatus of claim 59, wherein the mobility event comprises establishing connectivity with at least one network or modifying connectivity with the at least one network, wherein the at least one network includes the network.

61. The apparatus of claim 52, wherein the means for sending the cost information comprises means for sending the cost information via broadcast signaling.

62. An apparatus operable in a network communication device, comprising:
means for receiving a query for cost information associated with a network;
means for generating the cost information in response to receiving the query;
means for sending the cost information associated with the network, wherein the cost information comprises at least two or more of:
a first cost information for an access technology;
a second cost information for a wireless spectrum;
a third cost information for a subscription;
a fourth cost information for a high-level application;
a fifth cost information for a service class;
a sixth cost information for a location where service charging may occur;
a seventh cost information for particular traffic;
an eighth cost information for a time of day;
a ninth cost information for a first load of a particular cell;
a tenth cost information for a second load of a base station; or
an eleventh cost information for a dynamic entity.
